(19) United States
(12) Patent Application Publication
(10) Pub. No.: US 2026/0105346 A1
(43) Pub. Date: Apr. 16, 2026

(54) ERROR MITIGATION FOR CLIFFORD CIRCUITS VIA GENERALIZED PAULI CHECKS

(71) Applicant: International Business Machines Corporation, Armonk, NY (US)

(72) Inventors: Simon Martiel, Bordeaux (FR); Ali Javadiabhari, Sleepy Hollow, NY (US); Theodore James Yoder, Mohegan Lake, NY (US)

(21) Appl. No.: 18/914,598

(22) Filed: Oct. 14, 2024

(51) Int. Cl. G06N 10/70

(52) U.S. Cl. CPC G06N 10/70

(57) ABSTRACT

Systems/techniques that facilitate error mitigation for Clifford circuits via generalized Pauli checks are provided. In various embodiments, a system can perform a Clifford circuit on a set of data qubits. In various aspects, the system can detect an error in performance of the Clifford circuit by measuring a set of check qubits that control a set of Pauli operators that are inserted within the Clifford circuit. In various instances, a product of backpropagations of the set of Pauli operators can satisfy an error mitigation criterion. In some cases, the error mitigation criterion can be: that the product is equal, up to a global phase, to an identity operator; that the product is equal to a backpropagation of a randomly-inserted Pauli operator in the Clifford circuit; or that the product is present within a set of stabilizers associated with the Clifford circuit.

### BACKGROUND

The subject disclosure relates to quantum error mitigation.

### SUMMARY

The following presents a summary to provide a basic understanding of one or more embodiments. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, methods, or apparatuses that can facilitate error mitigation for Clifford circuits via generalized Pauli checks are described.

According to one or more embodiments, a system is provided. In various aspects, the system can comprise a processor that can execute computer-executable instructions stored in a non-transitory computer-readable memory. In various instances, such execution can cause the processor to facilitate various operations. In various cases, such operations can comprise performing a Clifford circuit on a set of data qubits. In various aspects, such operations can comprise detecting an error in performance of the Clifford circuit by measuring a set of check qubits that control a set of Pauli operators that are inserted within the Clifford circuit, wherein a product of backpropagations of the set of Pauli operators satisfies an error mitigation criterion.

In various aspects, the above-described system can be reformulated, reformatted, or otherwise implemented as a computer-implemented method or as a computer program product.

### DESCRIPTION OF THE DRAWINGS

FIG. 1 illustrates a block diagram of an example, non-limiting system that facilitates error mitigation for Clifford circuits via generalized Pauli checks in accordance with one or more embodiments described herein.

FIG. 2 illustrates a block diagram of an example, non-limiting system including a set of generalized Pauli checks and an error that facilitates error mitigation for Clifford circuits via generalized Pauli checks in accordance with one or more embodiments described herein.

FIG. 3 illustrates an example, non-limiting block diagram regarding a generalized Pauli check in accordance with one or more embodiments described herein.

FIGS. 4-6 illustrate example, non-limiting circuit diagrams regarding a generalized Pauli check in accordance with one or more embodiments described herein.

FIG. 7 illustrates a block diagram of an example, non-limiting system including a plurality of candidate locations that facilitates error mitigation for Clifford circuits via generalized Pauli checks in accordance with one or more embodiments described herein.

FIG. 8 illustrates an example, non-limiting block diagram showing how a set of generalized Pauli checks can be obtained or identified for a Clifford circuit when given a plurality of candidate locations in accordance with one or more embodiments described herein.

FIG. 9 illustrates a flow diagram of an example, non-limiting computer-implemented method that facilitates error mitigation for Clifford circuits via generalized Pauli checks in accordance with one or more embodiments described herein.

FIGS. 10-11 illustrate example, non-limiting circuit diagrams showing how a generalized Pauli check can work even for qubit topologies that have limited coupling in accordance with one or more embodiments described herein.

FIGS. 12-14 illustrate example, non-limiting circuit diagrams showing how a generalized Pauli check can involve daisy-chained check qubits in accordance with one or more embodiments described herein.

FIGS. 15-16 illustrate example, non-limiting experimental results in accordance with one or more embodiments described herein.

FIG. 17 illustrates a flow diagram of an example, non-limiting computer-implemented method that facilitates error mitigation for Clifford circuits via generalized Pauli checks in accordance with one or more embodiments described herein.

FIG. 18 illustrates a block diagram of an example, non-limiting operating environment in which one or more embodiments described herein can be facilitated.

### DETAILED DESCRIPTION

The following detailed description is merely illustrative and is not intended to limit embodiments or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

A quantum computer can be any suitable device that utilizes a qubit lattice (e.g., a plurality of superconducting qubits fabricated on one or more quantum substrates and exhibiting any suitable connection topology) for information processing. A quantum circuit can be a sequence of any suitable number of parallel or series quantum gates that can be executed on a quantum computer. A quantum gate can be a basic component of a quantum circuit that can change, alter, or otherwise affect the state of a qubit. As some non-limiting examples, a quantum gate can be any suitable single-qubit gate (e.g., Pauli-X gates, Pauli-Y gates, Pauli-Z gates, Phase gates, Rotation gates, Hadamard gates) or any suitable entangling or two-qubit gate (e.g., Controlled-Not gates, Controlled-Phase gates). Quantum gates can be combined in series via matrix multiplication or in parallel via tensor products. A Clifford circuit can be any quantum circuit that can be expressed using only Clifford gates; that is, that can be expressed using only Hadamard gates, Phase gates, or Controlled-Not gates. A quantum circuit can be considered as having a Clifford depth d, for any suitable positive integer d, if that quantum circuit can be represented as a composition of d Clifford circuits separated by arbitrary layers of single-qubit, non-Clifford gates.

Quantum error mitigation (QEM) can be considered as a set of tools or strategies for improving reliability of quantum circuits executed on noisy quantum hardware. Unlike quantum error correction (QEC), QEM can involve lower overhead in terms of ancillary qubits or circuit depth. Non-limiting examples of QEM can include Zero Noise Extrapolation, Probabilistic Error Cancellation, Virtual Entanglement Distillation, and Symmetry Verification.

Unfortunately, the vast majority of QEM techniques are applicable only to quantum algorithms that utilize expected value readouts (e.g., to algorithms that can access the output of a quantum circuit through expected values [symbol] ψ|0|ψ [symbol] , where |ψ [symbol] is the output state of the quantum circuit, and where O is some observable such as a Pauli operator). Such vast majority of QEM techniques are inapplicable to quantum algorithms that instead utilize single-shot readouts. That is, such vast majority of QEM techniques cannot mitigate errors in quantum algorithms that generate samples from the output probability distribution of a quantum circuit (e.g., that sample a bit string x from the probability distribution | [symbol] x|ψ [symbol] |²). This inapplicability to single-shot algorithms can be considered as problematic, since quantum algorithms that utilize single-shot readouts (e.g., Shor's Factoring Algorithm, Grover's Search Algorithm, Quantum Approximate Optimization Algorithm, Quantum Volume Algorithm, Quantum-Enhanced Markov Chain Monte Carlo Algorithm) can be considered as more computationally powerful than quantum algorithms that instead utilize expected value readouts (e.g., Variational Quantum Eigensolver).

One QEM technique that is applicable to quantum algorithms that utilize single-shot readouts is two-sided Pauli checking. Two-sided Pauli checking enables single-shot error mitigation for arbitrary circuits composed of Clifford gates. In particular, for any given Clifford circuit, a two-sided Pauli check detects errors in that given Clifford circuit by verifying, on an ancillary qubit, commutation rules (e.g., commutative identities or equivalences) between that given Clifford circuit and a pair of Pauli operators that are controlled by the ancillary qubit and that sandwich (e.g., that flank, that are on both left and right sides of) that given Clifford circuit. Due to such sandwiching, a two-sided Pauli check can be referred to as a Pauli sandwich. To increase the likelihood of detecting an error, multiple two-sided Pauli checks, each controlled by a respective or unique ancillary qubit, can be nested together around the given Clifford circuit. For case of explanation, the qubits on which the given Clifford circuit and the controlled Pauli operators operate can be referred to as data qubits, whereas the ancillary qubits that control the controlled Pauli operators can instead be referred to as check qubits.

Although two-sided Pauli checking can enable single-shot error mitigation and thus can be considered as advantageous over the vast majority of QEM techniques, the inventors of various embodiments described herein realized that two-sided Pauli checking can nevertheless be considered as suffering from various disadvantages.

Specifically, the present inventors realized that two-sided Pauli checking suffers from significant hardware restrictions. Indeed, two-sided Pauli checks are generally implemented via an all-to-all connection topology between check qubits and data qubits. In other words, two-sided Pauli checking usually requires that each data qubit be physically coupled to each check qubit, so that each two-sided Pauli check can be controlled by a respective check qubit. Unfortunately, such an all-to-all connection topology can be considered as a complicated and difficult hardware architecture to implement, and such complication and difficulty can become exacerbated as the data qubits and check qubits grow in number. Now, such all-to-all connection topology can be eschewed by implementing interleaved SWAP gates. That is, each n-qubit controlled Pauli operator of a two-sided Pauli check can be considered as a tensor product of n controlled Pauli gates, for any suitable positive integer n, and each of such controlled Pauli gates can be followed by a respective SWAP gate. In other words, SWAP gates can be interleaved, interspersed, or otherwise interdigitated throughout the two-sided Pauli check. When implemented on a linear nearest neighbor connection topology (which can be easier or less complicated to construct than an all-to-all coupling topology), such interleaved SWAP gates can cause the logical state of each data qubit and the logical state of each check qubit to, at some point, be coupled together. More generally, for any given connection topology and for any given controlled Pauli gate, SWAP gates can be executed until the target qubit and the control qubit of that given controlled Pauli gate become coupled neighbors. At such point, the given controlled Pauli gate can be executed, and even more SWAP gates can be executed so as to return the qubit connectivity back to its original ordering. This process can be repeated for any suitable number of controlled Pauli gates. Although such utilization of SWAP gates can allow two-sided Pauli checks to be performed in the absence of an all-to-all connection topology, it significantly increases circuit depth and thus computational overhead (e.g., the number of SWAP gates needed can grow exponentially with the number of data qubits or check qubits). Accordingly, two-sided Pauli checks require an undesirable tradeoff between architectural complexity and circuit depth (e.g., can utilize lower circuit depth if a difficult-to-implement hardware topology is used; or can use an easy-to-implement hardware topology if circuit depth is significantly increased via SWAP gates).

Additionally, the present inventors realized that two-sided Pauli checks can be considered as having post-selection rates that are not as high as they otherwise could be and as having logical error rates that are not as low as they otherwise could be. The term “post-selection rate” can refer to the probability or likelihood that a set of Pauli checks associated with a given Clifford circuit all indicate that no error has occurred during performance of the given Clifford circuit. In contrast, the term “logical error rate” can refer to the probability or likelihood that an error has occurred during performance of the given Clifford circuit, notwithstanding all of the set of two-sided Pauli checks indicating that no error has occurred. In other words, the term “post-selection rate” can be considered as the probability of the set of Pauli checks indicating the absence of errors, and the term “logical error rate” can instead be considered as the probability of the set of Pauli checks producing false negatives (e.g., inaccurately indicating the absence of errors). It can be desired to maximize or otherwise increase the post-selection rate while simultaneously minimizing or otherwise decreasing the logical error rate.

The present inventors devised various techniques described herein, which can help to address or ameliorate various of the above-described technical problems that plague two-sided Pauli checks. In particular, the present inventors devised what they refer to as a generalized Pauli check. As described herein, a generalized Pauli check can include or otherwise be made up of one or more controlled Pauli operators that are inserted inside of, within, or otherwise throughout a given Clifford circuit, such that a multiplicative product of backpropagations of those one or more controlled Pauli operators satisfies some error mitigation criterion. In some instances, the error mitigation criterion can be that the multiplicative product is equal (without taking phase into consideration) to an identity operator. In other instances, the error mitigation criterion can instead be that the multiplicative product is equal to the backpropagation of some other Pauli operator that is randomly inserted into the given Clifford circuit. In even other instances, the error mitigation criterion can be that the multiplicative product is an element of a stabilizer group that is known to be associated with the given Clifford circuit. In any of such cases, so long as the error mitigation criterion is satisfied, the one or more controlled Pauli operators can function or otherwise serve as a valid Pauli check of the given Clifford circuit. Unlike a two-side Pauli check, a generalized Pauli check as described herein requires neither any specific hardware topology nor implementation of interleaved SWAP gates. In other words, as described herein, a generalized Pauli check can be identified for the given Clifford circuit no matter the qubit coupling topology on which the given Clifford circuit is to be executed. Thus, various embodiments described herein can be considered as having significantly reduced or relaxed hardware constraints or computational overhead as compared to two-sided Pauli checks. Furthermore, the present inventors experimentally verified that a set of generalized Pauli checks can exhibit a significantly higher post-selection rate and a significantly lower logical error rate than a comparable set of two-sided Pauli checks. That is, not only do various embodiments described herein have fewer constraints and lower overhead than two-sided Pauli checks, but such embodiments also significantly outperform two-sided Pauli checks in terms of error mitigation capabilities. Accordingly, various embodiments described herein can be considered as technical improvements over two-sided Pauli checking.

Various embodiments described herein can be considered as a computerized tool (e.g., any suitable combination of computer-executable hardware or computer-executable software) that can facilitate error mitigation for Clifford circuits via generalized Pauli checks. In various aspects, such a computerized tool can comprise an access component and a detection component.

In various embodiments, there can be a quantum computer. In various aspects, the quantum computer can comprise any suitable number of qubits. In various instances, such qubits can exhibit any suitable structures, constructions, or architectures (e.g., can be superconducting qubits, spin qubits, or quantum dots). In various cases, some of such qubits can be considered or otherwise referred to as data qubits, and others of such qubits can be considered or otherwise referred to as check qubits. In various aspects, the data qubits and check qubits of the quantum computer can be arranged or connected according to any suitable coupling topology.

In various instances, there can be a Clifford circuit. In various cases, the Clifford circuit can be configured to operate on the data qubits of the quantum computer.

In various aspects, it can be desired to execute, in single-shot noise mitigated fashion, the Clifford circuit on the data qubits of the quantum computer. As described herein, the computerized tool can facilitate such execution.

In various embodiments, the access component of the computerized tool can electronically access, via any suitable wired or wireless electronic connections, the quantum computer. In various instances, the access component can further access or otherwise receive, retrieve, or import from any suitable source the Clifford circuit. For example, the access component can obtain the Clifford circuit from any suitable centralized or decentralized data structure (e.g., graph data structure, relational data structure, hybrid data structure), whether remote from or local to the access component. In any case, the access component can access the quantum computer or the Clifford circuit, such that other components of the computerized tool can electronically interact with (e.g., power-up, power-down, initialize, control) the quantum computer or can electronically interact with (e.g., read, write, edit, copy, manipulate, execute) the Clifford circuit.

In various embodiments, the detection component of the computerized tool can electronically detect an error of the Clifford circuit, by leveraging a set of generalized Pauli checks. More specifically, a generalized Pauli check can be one or more Pauli operators that can operate on the data qubits of the quantum computer, that can be inserted inside of or otherwise throughout the Clifford circuit, and that can be controlled by a respective or unique check qubit of the quantum computer. In various aspects, the one or more Pauli operators can be selected so that their backpropagations (e.g., to a front or beginning of the Clifford circuit) can have a multiplicative product that satisfies any suitable error mitigation criterion. In some instances, that error mitigation criterion can be that the multiplicative product of the backpropagations is equal to an identity operator, up to a global phase (e.g., when phase information is ignored). In other instances, that error mitigation criterion can be that the multiplicative product of the backpropagations is equal to the backpropagation of some other Pauli operator that has been randomly inserted into the Clifford circuit. In yet other instances, that error mitigation criterion can be that the multiplicative product of the backpropagations is an element of a stabilizer group that is known to be associated with the Clifford circuit. In any of such cases, the detection component can initialize the data qubits and the check qubits in any suitable fashion (e.g., all initialized to |0 [symbol] ) and can execute the Clifford circuit and the generalized Pauli checks on the quantum computer. After such execution, the detection component can measure, in any suitable basis (e.g., the X-basis) the quantum states of the check qubits and of the data qubits.

In various aspects, the measured states of the check qubits can be considered as indicating whether or not an error was detected within the Clifford circuit. For example, if each of the measured states of the check qubits is |0 [symbol] , then the detection component can conclude that no error was detected in the Clifford circuit (e.g., can conclude that either no error occurred in the Clifford circuit or that an undetected error occurred in the Clifford circuit). In such case, the measured states of the data qubits can be considered as reliable. On the other hand, if at least one of the measured states of the check qubits is |1 [symbol] , then the detection component can conclude that an error was detected in the Clifford circuit. In such case, the measured states of the data qubits can be considered as unreliable (e.g., as tainted by some error). So, the detection component can reinitialize the data qubits and the check qubits and can re-execute the Clifford circuit and the generalized Pauli checks until all of the measured states of the check qubits are |0 [symbol] . In other words, the detection component can post-select on the check qubits all being |0 [symbol] .

In various aspects, each particular generalized Pauli check can be considered as being able to detect some proportion of whatever errors (e.g., Pauli errors) might occur in the Clifford circuit. In other words, each additional generalized Pauli check can be considered as progressively or incrementally reducing the proportion of undetected errors that might occur in the Clifford circuit, regardless of the particular form of the Clifford circuit. In still other words, the generalized Pauli checks can significantly reduce the likelihood that a non-identity error affects the Clifford circuit yet goes undetected, and such error reduction applies no matter which specific Clifford gates are implemented in the Clifford circuit and no matter how those specific Clifford gates are arranged or ordered.

Note that a generalized Pauli check requires neither any special qubit coupling topology nor interleaved SWAP gates in order to work or function. That is, valid generalized Pauli checks can be identified for any Clifford circuit, regardless of the specific coupling topology that is used to perform the Clifford circuit.

In particular, the detection component can, in some embodiments, identify which generalized Pauli checks to use for the Clifford circuit, based on a plurality of candidate locations that are associated with the Clifford circuit. In some aspects, the plurality of candidate locations can be identified or provided by a user or technician of the quantum computer (e.g., via any suitable human-computer interface device, such as a keyboard or touchscreen), with each candidate location being a qubit-timestep tuple within the Clifford circuit that is designated or denoted as suitable or acceptable for insertion of Pauli operators. In other words, each candidate location can be any suitable electronic data that specifies: a respective data qubit that a controlled Pauli operator could possibly treat as a target (e.g., data qubits that are not coupled to any check qubit can be omitted from the plurality of candidate locations); and a respective circuit timestep at which a controlled Pauli operator could be executed on that respective data qubit (e.g., the circuit timestep can indicate where in the sequence of all quantum gates that are to be executed on that respective data qubit a controlled Pauli operator could be inserted or placed). In some instances, the plurality of candidate locations can strategically include “holes” of the Clifford circuit, where a “hole” can be some qubit-timestep tuple within the Clifford circuit at which no quantum gate of the Clifford circuit is to be executed.

In any case, each given candidate location could be filled with one of three candidate Pauli operators: a weight-1 controlled Pauli-X operator can be inserted at that given candidate location; a weight-1 controlled Pauli-Y operator can be inserted at that given candidate location; or a weight-1 controlled Pauli-Z operator can be inserted at that given candidate location. Thus, the plurality of candidate locations can be considered as respectively corresponding to a plurality of candidate Pauli operators. In various aspects, the detection component can compute a respective backpropagation for each of that plurality of candidate Pauli operators, thereby yielding a plurality of backpropagations. In various instances, the detection component can convert each of the plurality of backpropagations into a respective Boolean encoding (e.g., into a respective bit string), thereby yielding a plurality of Boolean encodings. In various cases, the detection component can stack the plurality of Boolean encodings on top of each other, thereby yielding a stacked array. In some aspects, the detection component can randomly shuffle the stacked array. In various instances, the detection component can identify which generalized Pauli checks are valid for the Clifford circuit, based on analyzing the stacked array in accordance with the error mitigation criterion. As a non-limiting example, if the error mitigation criterion is equality to an identity operator, the detection component can identify the generalized Pauli checks by computing a nullspace of the stacked array (e.g., by identifying which combinations of rows of the stacked array sum to zero). As another non-limiting example, if the error mitigation criterion is equality to the backpropagation of a randomly-inserted Pauli operator or membership of a stabilizer group of the Clifford circuit, the detection component can identify the generalized Pauli checks by applying any suitable syndrome decoding technique to the stacked array. In any case, the detection component can be considered as performing linear algebra operations on the stacked area, so as to identify which combinations of rows of the stacked array, and thus which combinations of the plurality of candidate Pauli operators, form valid generalized Pauli checks. After such search, the detection component can insert one or more of those valid generalized Pauli checks into the Clifford circuit.

Therefore, generalized Pauli checks as described herein can be applied regardless of the hardware coupling topology that will be used to execute the Clifford circuit, and without interleaving voluminous amounts of SWAP gates into the Clifford circuit. Contrast this with two-sided Pauli checks, which require either: all-to-all coupling topologies that are extremely difficult to fabricate; or myriad SWAP gates in the absence of all-to-all coupling topologies, thereby having excessively lengthened circuit depths.

Additionally, the present inventors experimentally verified that generalized Pauli checks can outperform two-sided Pauli checks in terms of error mitigation. Indeed, various experiments conducted by the present inventors confirmed that a set of generalized Pauli checks can achieve both a significantly increased post-selection rate and a significantly decreased logical error rate, as compared to a comparable set of two-sided Pauli checks. Thus, not only are generalized Pauli checks more relaxed in terms of hardware constraints and circuits depths as compared to two-sided Pauli checks, but generalized Pauli checks also provide enhanced or improved error mitigation than two-sided Pauli checks.

Various embodiments described herein can be employed to use hardware or software to solve problems that are highly technical in nature (e.g., to facilitate improved error mitigation for Clifford circuits via generalized Pauli checks), that are not abstract and that cannot be performed as a set of mental acts by a human. Further, some of the processes performed can be performed by a specialized computer (e.g., quantum computers comprising tangible qubits that can execute or implement quantum circuits). In various aspects, some defined tasks associated with various embodiments described herein can include: performing, by a device operatively coupled to a processor, a Clifford circuit on a set of data qubits; and detecting, by the device, an error in performance of the Clifford circuit by measuring a set of check qubits that control a set of Pauli operators that are inserted within the Clifford circuit, wherein a product of backpropagations of the set of Pauli operators satisfies an error mitigation criterion. In some instances, the device can identify the set of Pauli operators to be inserted within the Clifford circuit based on: computing, by the device, respective backpropagations for candidate Pauli operators associated with candidate locations in the Clifford circuit, thereby yielding a plurality of candidate backpropagations; stacking, by the device, respective Boolean encodings of the plurality of candidate backpropagations, thereby yielding a stacked array; and computing, by the device, a nullspace of the stacked array or otherwise applying, by the device, a syndrome decoding algorithm or technique to the stacked array. In some cases, the error mitigation criterion can be that the product is equal, up to a global phase, to an identity operator. In other cases, the error mitigation criterion can be that the product is equal to a backpropagation of a randomly-inserted Pauli operator in the Clifford circuit. In still other cases, the error mitigation criterion can be that the product is present within a set of stabilizers associated with the Clifford circuit.

Neither the human mind nor a human with pen and paper can electronically access a Clifford circuit, electronically insert controlled Pauli operators into the Clifford circuit so that a multiplicative product of their backpropagations satisfies some threshold criterion, and electronically detect errors in that Clifford circuit by executing the controlled Pauli operators. After all, a quantum computer is a specialized piece of computing hardware that utilizes physical qubits (e.g., superconducting qubits, such as transmons) to process information. Physical qubits cannot be implemented by the human mind or by a human with pen and paper. Moreover, a quantum circuit can be a sequence of quantum gates that can be executed on a quantum computer. Neither the human mind, nor a human with pen and paper, can insert quantum gates (e.g., controlled Pauli operators) into a Clifford circuit or execute quantum gates on physical qubits. Therefore, a computerized tool that can detect errors in a Clifford circuit via implementation of controlled Pauli checks that are inserted into the Clifford circuit such that their backpropagations satisfy some threshold criterion is inherently computerized and cannot be implemented in any sensible, practicable, or reasonable way without computers.

In various instances, one or more embodiments described herein can integrate the herein-described teachings into a practical application. As mentioned above, existing techniques for facilitating single-shot error mitigation utilize two-sided Pauli checks. As also mentioned above, the present inventors recognized that two-sided Pauli checks suffer from various technical problems.

First, the present inventors realized that two-sided Pauli checks require an undesirable tradeoff between hardware complexity and circuit depth. Indeed, two-sided Pauli checks usually assume an all-to-all qubit coupling topology. An all-to-all qubit coupling topology means that each check qubit is physically coupled to each data qubit, such that a two-qubit entangling gate can be executed between each unique check-data qubit pair. Unfortunately, physically constructing or fabricating an all-to-all qubit coupling topology is not a trivial task: such construction or fabrication involves complicated resonator layouts and increased risks of quantum crosstalk or interference. In other words, an all-to-all coupling topology can be considered as a difficult, burdensome, or expensive hardware architecture. Now, two-sided Pauli checks can be implemented on topologies that are less complex than an all-to-all qubit coupling topology (e.g., can be implemented on a linear nearest neighbor topology, which can be considered as easier to build), but such implementation requires the inclusion of very many (e.g., tens of, hundreds of, thousands of) SWAP gates. Such voluminous SWAP gates can be considered as drastically increasing the circuit depth and thus computational overhead associated with two-sided Pauli checks.

Secondly, the present inventors realized that the error mitigation performance exhibited two-sided Pauli checks leaves room for improvement. Specifically, the present inventors recognized that it would be beneficial to increase the post-selection rates achievable by two-sided Pauli checks and to decrease the logical error rates achievable by two-sided Pauli checks.

Accordingly, the present inventors devised various embodiments described herein, which can be considered as solving, addressing, or otherwise ameliorating the technical problems that afflict two-sided Pauli checks. In particular, various embodiments described herein can include detecting errors in a Clifford circuit via implementation of what the present inventors call a generalized Pauli check. As described herein, a generalized Pauli check can be or otherwise include one or more controlled, weight-1 Pauli operators that are inserted inside of the Clifford circuit, such that a multiplicative product of backpropagations of the one or more controlled, weight-1 Pauli operators satisfies some criterion (e.g., equality to an identity operator; equality to the backpropagation of some randomly-inserted Pauli operator; presence within a stabilizer group of the Clifford circuit). A generalized Pauli check can serve the same function or purpose as a two-sided Pauli check, but without sacrificing circuit depth in order to reduce hardware complexity. Indeed, a generalized Pauli check does not require any special or specific qubit coupling topology (e.g., does not require an all-to-all coupling topology). Instead, a valid generalized Pauli check can be identified (e.g., by analyzing a stacked array of Boolean encodings of backpropagations of candidate Pauli operators) for any given topology and without relying upon interleaved SWAP gates. Thus, a generalized Pauli check can be considered as having significantly fewer hardware constraints than a two-sided Pauli check. Additionally, experiments conducted by the present inventors show that generalized Pauli checks can achieve higher post-selection rates and lower logical error rates than two-sided Pauli checks. In other words, the present inventors experimentally verified that generalized Pauli checks as described herein can exhibit significantly better error mitigation performance than two-sided Pauli checks. Such embodiments can thus be considered as providing quantifiable performance improvements in the field of quantum error mitigation. For example, single-shot error detection via generalized Pauli checks can exhibit a higher level of accuracy or reliability (or can achieve a comparable level of accuracy by using fewer checks) as compared to existing techniques. As another example, single-shot error detection via generalized Pauli checks can consume fewer computational resources (e.g., can require the execution of fewer quantum gates) as compared to existing techniques. As yet another example, single-shot error detection via generalized Pauli checks can relax hardware architecture requirements or otherwise reduce Controlled-Not (CNOT) costs as compared to existing techniques. These are concrete and tangible technical improvements or technical effects in the field of quantum circuits. For at least these reasons, various embodiments described herein certainly constitute useful and practical applications of computers.

It should be appreciated that the figures and the herein disclosure describe non-limiting examples of various embodiments. It should further be appreciated that the figures are not necessarily drawn to scale.

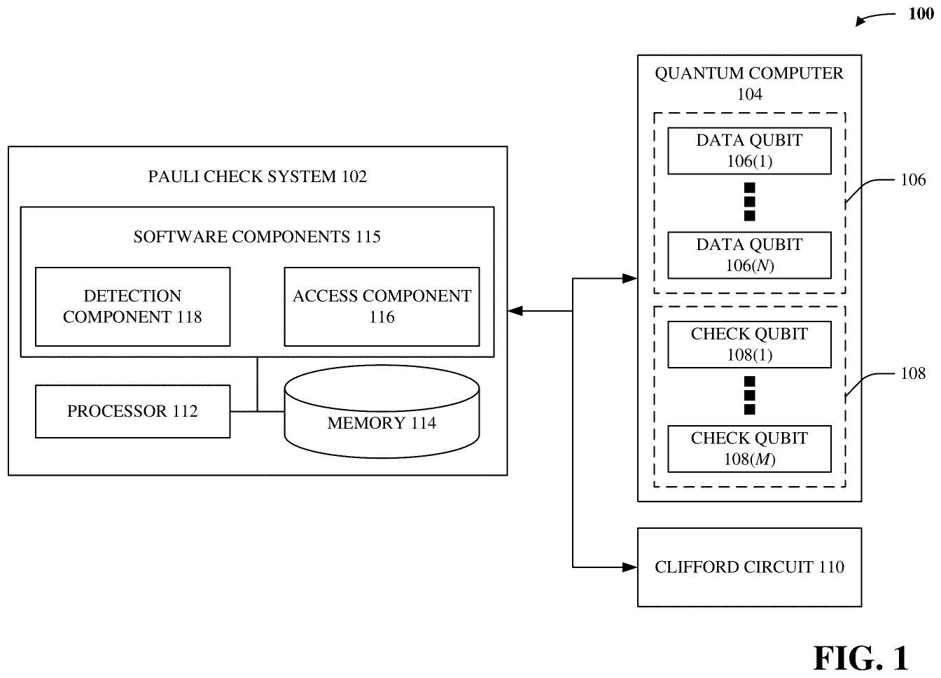

FIG. 1 illustrates a block diagram of an example, non-limiting system 100 that can facilitate error mitigation for Clifford circuits via generalized Pauli checks in accordance with one or more embodiments described herein. As shown, a Pauli check system 102 can be electronically integrated, via any suitable wired or wireless electronic connections, with a quantum computer 104 and with a Clifford circuit 110.

In various embodiments, the quantum computer 104 can be any suitable quantum computing device or quantum computing hardware. In various aspects, the quantum computer 104 can comprise a set of data qubits 106. In various instances, the set of data qubits 106 can comprise n qubits for any suitable positive integer n: a data qubit 106(1) to a data qubit 106(n). In various cases, the quantum computer 104 can comprise a set of check qubits 108. In various aspects, the set of check qubits 108 can comprise m qubits for any suitable positive integer m: a check qubit 108(1) to a check qubit 108(m). In various instances, any of the set of data qubits 106 or any of the set of check qubits 108 can exhibit any suitable structure or architecture. As a non-limiting example, any of such qubits can exhibit a superconducting qubit architecture (e.g., such qubit can be constructed from any suitable number of Josephson junctions shunted by any suitable number of planar capacitor pads). As another non-limiting example, any of such qubits can exhibit a quantum dot architecture. As yet another non-limiting example, any of such qubits can exhibit a spin qubit architecture. In various aspects, different qubits of the set of data qubits 106 or of the set of check qubits 108 can exhibit the same or different structures or architectures as each other. Although not explicitly shown in FIG. 1, the quantum computer 104 can comprise or otherwise be associated with any suitable hardware or software (e.g., real-time controllers implemented in field programmable gate arrays of the quantum computer 104) that can be used to initialize any of the set of data qubits 106 or any of the set of check qubits 108, or that can be used to perform any suitable quantum operations (e.g., quantum gates, qubit measurements, qubit idling) on the set of data qubits 106 or on the set of check qubits 108.

In various aspects, the Clifford circuit 110 can be any suitable sequence of Clifford gates (e.g., Hadamard gates (H), Phase gates(S), or CNOT gates) that can be executed in parallel or in series on the set of data qubits 106. Accordingly, in various instances, the Clifford circuit 110 can be considered as being an n-qubit Clifford circuit (e.g., as being a Clifford circuit that can operate on n qubits, as being an n-order tensor product; as being a 2″×2″ matrix). In some cases, the Clifford circuit 110 can be a Clifford layer within a larger, possibly non-Clifford quantum circuit.

In various instances, it can be desired to execute the Clifford circuit 110 on the set of data qubits 106 with single-shot error mitigation. As described herein, the Pauli check system 102 can facilitate such execution and single-shot error mitigation.

In various embodiments, the Pauli check system 102 can comprise a processor 112 (e.g., computer processing unit, microprocessor) and a non-transitory computer-readable memory 114 that is operably connected or coupled to the processor 112. The memory 114 can store computer-executable instructions which, upon execution by the processor 112, can cause the processor 112 or other components of the Pauli check system 102 (e.g., access component 116, detection component 118) to perform one or more acts. In various embodiments, the memory 114 can store computer-executable components (e.g., access component 116, detection component 118), and the processor 112 can execute the computer-executable components.

In various embodiments, the Pauli check system 102 can comprise an access component 116. In various aspects, the access component 116 can electronically access, in any suitable fashion, the quantum computer 104, such that the Pauli check system 102 can initialize, electronically activate (e.g., power-up), electronically deactivate (e.g., power-down), or otherwise electronically control the quantum computer 104. Furthermore, in various instances, the access component 116 can electronically receive, retrieve, obtain, import, or otherwise access, from any suitable data structures or from any suitable computing devices, the Clifford circuit 110. In any case, the access component 116 can electronically access (e.g., send or receive data or program instructions to or from) the quantum computer 104 or the Clifford circuit 110, such that other components of the Pauli check system 102 can electronically interact with the quantum computer 104 or with the Clifford circuit 110.

In various embodiments, the Pauli check system 102 can comprise a detection component 118. In various instances, the detection component 118 can electronically execute the Clifford circuit 110 on the set of data qubits 106. In some cases, as described herein, the detection component 118 can electronically detect an error associated with such execution by leveraging a set of generalized Pauli checks that are inserted throughout the Clifford circuit 110 and that are respectively controlled by the set of check qubits 108.

Note that, in various instances, the access component 116 and the detection component 118 can collectively be considered as being one or more software components 115 of the Pauli check system 102. In various aspects, it should be appreciated that the one or more software components 115 are described primarily herein as comprising two components (e.g., the access component 116, the detection component 118) for case of explanation and illustration. However, the one or more software components 115 are not limited to being implemented as exactly such two components in every embodiment. Indeed, in some embodiments, the functionalities described herein of such two components can be combined in any suitable fashions, so as to be implemented in or by fewer than two components (e.g., in some cases, a single component can perform all of the functionalities that are described herein with respect to the access component 116 and the detection component 118). In other embodiments, the functionalities described herein of such two components can instead be distributed, separated, split, or fragmented in any suitable fashions, so as to be implemented in or by more than two components (e.g., two or more components can facilitate the functionalities that are performable by the access component 116; two or more components can facilitate the functionalities that are performable by the detection component 118).

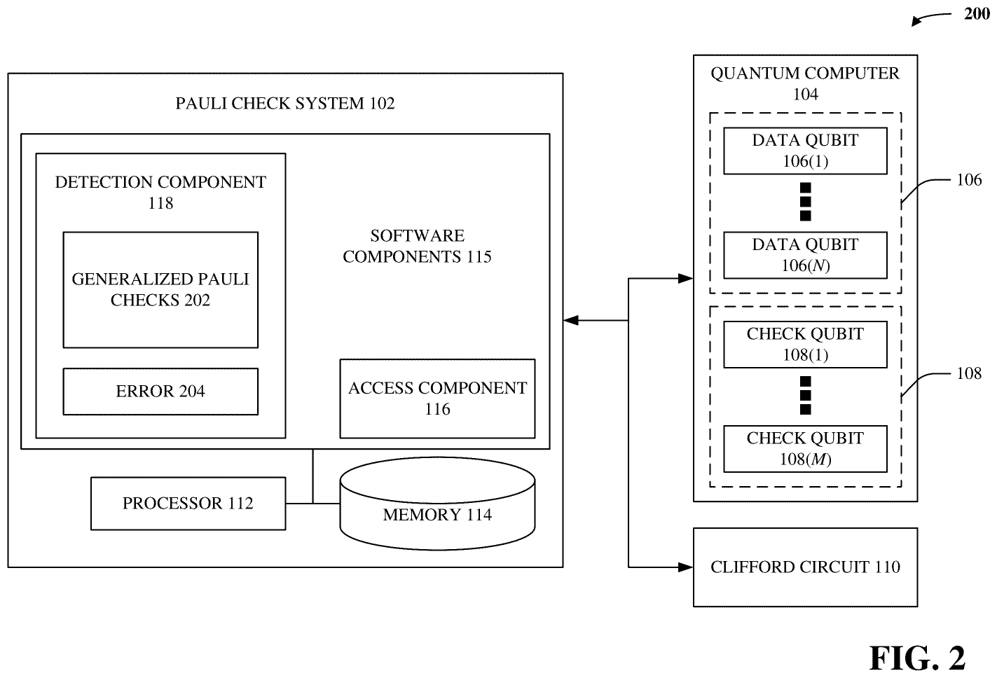

FIG. 2 illustrates a block diagram of an example, non-limiting system 200 including a set of generalized Pauli checks and an error that can facilitate error mitigation for Clifford circuits via generalized Pauli checks in accordance with one or more embodiments described herein. As shown, the system 200 can, in some cases, comprise the same components as the system 100, and can further comprise a set of generalized Pauli checks 202 and an error 204.

In various aspects, the set of generalized Pauli checks 202 can respectively correspond (e.g., in one-to-one fashion) to the set of check qubits 108. Accordingly, since the set of check qubits 108 can comprise m qubits, the set of generalized Pauli checks 202 can comprise m Pauli checks: a first generalized Pauli check to an m-th generalized Pauli check. In various instances, each of the set of generalized Pauli checks 202 can comprise one or more weight-1, non-identity Pauli operators that operate on the set of data qubits 106, that are controlled by a respective one of the set of check qubits 108, and that are inserted by the detection component 118 inside of or otherwise within the Clifford circuit 110.

As a non-limiting example, the first generalized Pauli check of the set of generalized Pauli checks 202 can be or otherwise include one or more n-qubit Pauli operators each of which can be a tensor product among a non-identity, 1-qubit Pauli gate (e.g., a 2×2 Pauli-X gate, a 2×2 Pauli-Y gate, or a 2×2 Pauli-Z gate) and a total of (n−1) 1-qubit identity gates (e.g., n−1 copies or instantiations of a 2×2 identity gate), where the 1-qubit Pauli gate can operate on any of the set of data qubits 106, and wherein the 1-qubit Pauli gate can be controlled by the check qubit 108(1). Note that which specific one of the set of data qubits 106 that the non-identity, 1-qubit Pauli gate is configured to operate on can dictate where that non-identity, 1-qubit Pauli gate is located in the tensor product.

As another non-limiting example, the m-th generalized Pauli check of the set of generalized Pauli checks 202 can be or otherwise include one or more n-qubit Pauli operators each of which can be a tensor product among a non-identity, 1-qubit Pauli gate and a total of (n−1) 1-qubit identity gates, where that 1-qubit Pauli gate can operate on any of the set of data qubits 106, and wherein that 1-qubit Pauli gate can be controlled by the check qubit 108(m). Just as above, which specific one of the set of data qubits 106 that the non-identity, 1-qubit Pauli gate is configured to operate on can dictate where that non-identity, 1-qubit Pauli gate is located in the tensor product.

In any case, for a given generalized Pauli check of the set of generalized Pauli checks 202, the detection component 118 can insert whatever weight-1, non-identity Pauli operators that make up that given generalized Pauli check inside of the Clifford circuit 110, such that a multiplicative product of backpropagations of those weight-1, non-identity Pauli operators satisfies any suitable error mitigation criterion.

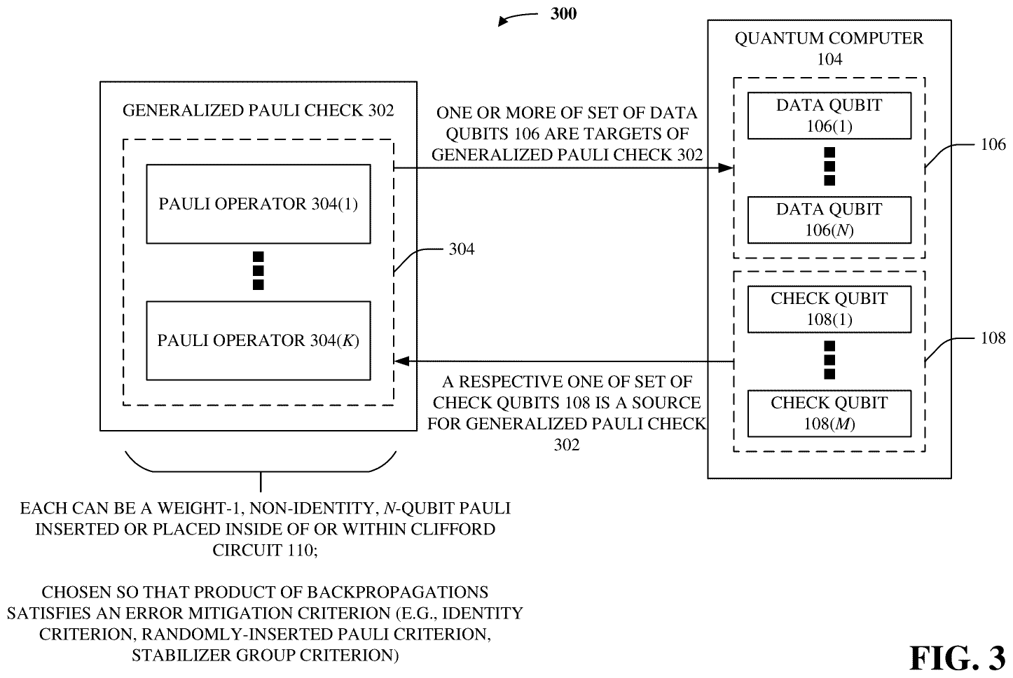

In various aspects, the detection component 118 can electronically execute the set of generalized Pauli checks 202 and the Clifford circuit 110 on the quantum computer 104, and resulting measured states of the set of check qubits 108 can indicate, convey, or otherwise represent whether or not an n-qubit Pauli error associated with the Clifford circuit 110 was detected. In various cases, such error can be referred to as the error 204. In various aspects, the detection component 118 can repeatedly execute the Clifford circuit 110 and the set of generalized Pauli checks 202, until the error 204 is not detected. Various non-limiting aspects are described with respect to FIGS. 3-6.

FIG. 3 illustrates an example, non-limiting block diagram 300 regarding a generalized Pauli check in accordance with one or more embodiments described herein.

In various embodiments, a generalized Pauli check 302 can be any one of the set of generalized Pauli checks 202. In various aspects, as shown, the generalized Pauli check 302 can have, possess, or otherwise be made up of a set of Pauli operators 304. In various instances, the set of Pauli operators 304 can include k operators, for any suitable positive integer k: a Pauli operator 304(1) to a Pauli operator 304(k). In various instances, each of the set of Pauli operators 304 can be a weight-1, non-identity Pauli operator that is configured to operate on any of the set of data qubits 106 and that is controlled by a single, common one of the set of check qubits 108.

As a non-limiting example, suppose that the generalized Pauli check 302 is controlled by a check qubit 108(j), for any suitable positive integer 1≤j≤m. In such case, the Pauli operator 304(1) can be a first 2″×2″ matrix (e.g., a first n-qubit matrix) that is formed by the tensor product of: any 2×2, non-identity Pauli gate; and n−1 instantiations of the 2×2 identity gate. More specifically, suppose that the Pauli operator 304(1) is configured to operate on a data qubit 106(i), for any suitable positive integer 1≤i≤n. In such case, the Pauli operator 304(1) can be equal to I^{⊗i-1}⊗P_{j,i}⊗I^{⊗n-i}, where Pit is a 2×2, non-identity Pauli gate (e.g., a 2×2 Pauli-X gate, a 2×2 Pauli-Y gate, or a 2×2 Pauli-Z gate) that is configured to be controlled by the check qubit 108(j) and to operate on the data qubit 106(i), and where/is a 2×2 identity matrix. Likewise, the Pauli operator 304(k) can be a k-th 2″×2″ matrix (e.g., a k-th n-qubit matrix) that is formed by the tensor product of: any 2×2, non-identity Pauli gate; and n−1 instantiations of the 2×2 identity gate. In particular, suppose that the Pauli operator 304(k) is configured to operate on a data qubit 106(g), for any suitable positive integer 1≤g≤n. In such case, the Pauli operator 304(k) can be equal to I^{⊗g-1}⊗I^{⊗n-g}, where P_{j,g} is a 2×2, non-identity Pauli gate that is configured to be controlled by the check qubit 108(j) and to operate on the data qubit 106(g).

Note that different ones of the set of Pauli operators 304 can operate on the same or different ones of the set of data qubits 106. Likewise, note that different ones of the set of Pauli operators 304 can operate at the same or different circuit timesteps as each other. Indeed, in some cases, any of the set of Pauli operators 304 can be configured to be performed simultaneously or in parallel with each other, or any of the set of Pauli operators 304 can be configured to be performed sequentially or in series with each other. Note that any two of the set of Pauli operators 304 that are configured to operate sequentially or in series with each other can, in some cases, be separated by no quantum gates of the Clifford circuit 110, or can, in other cases, be separated by one or more quantum gates of the Clifford circuit 110. That is, any two Pauli operators that are configured to be executed at different circuit timesteps can be considered as being chronologically sequential (e.g., one executed before the other), notwithstanding that those two Pauli operators might not be configured to be executed at directly adjacent timesteps. Additionally, it should be understood or otherwise appreciated that no two of the set of Pauli operators 304 can be configured to perform a non-identity operation on the same data qubit simultaneously as each other. That is, if any two or more of the set of Pauli operators 304 are configured to perform respective non-identity operation on the same data qubit as each other, those two or more of the set of Pauli operators 304 can be considered as being configured to be performed at different circuit timesteps than each other (e.g., as being configured to not be performed simultaneously as each other). Conversely, if two or more of the set of Pauli operators 304 are configured to perform respective non-identity operation simultaneously or in parallel with each other, those two or more of the set of Pauli operators 304 can be considered as being configured to perform those respective non-identity operations on different data qubits than each other.

In various aspects, the detection component 118 can electronically insert or place the set of Pauli operators 304 inside of or within the Clifford circuit 110 (e.g., the set of Pauli operators 304 can be interspersed throughout the Clifford circuit 110), such that a multiplicative product of backpropagations of the set of Pauli operators 304 satisfies any suitable error mitigation criterion. More specifically, let

$${P}_{i}^{n}$$

represent an i-th one of the set of Pauli operators 304 for any suitable positive integer 1≤i≤k (the superscript n can represent that

$${P}_{i}^{n}$$

is an n-qubit Pauli operator, as opposed to a 1-qubit Pauli gate). Furthermore, let C_{before} represent all of the quantum gates of the Clifford circuit 110 that are configured to be executed prior to

$${P}_{i}^{n} ,$$

and let C_{after} represent all of the quantum gates of the Clifford circuit 110 that are configured to be executed after

$${P}_{i}^{n} .$$

Note that, if any quantum gates of the Clifford circuit 110 are configured to be executed at a same circuit timestep (but on different data qubits) as

$${P}_{i}^{n} ,$$

that circuit timestep can be split or fragmented into two new circuit timesteps, with one of those two new circuit timesteps occurring directly before the other. Thus,

$${P}_{i}^{n}$$

can be assigned to either of those two new circuit timesteps, those quantum gates can be assigned to the other of those two new circuit timesteps, and those quantum gates can accordingly be considered as part of C_{before} Or C_{after} as appropriate. In any case, the detection component 118 can compute a backpropagation of

$${P}_{i}^{n}$$

to a beginning, start, or from or the Clifford circuit 110 as follows:

$$B ( {P}_{i}^{n} ) = {C}_{before}^{†} {P}_{i}^{n} {C}_{before}$$

where

$$B ( {P}_{i}^{n} )$$

can represent the backpropagation of

$${P}_{i}^{n} ,$$

and where C_{before} † can represent the conjugate transpose of C_{before}. Using the above formulation,

$$B ( {P}_{i}^{n} )$$

can be considered as an n-qubit operator that is positioned or located immediately or directly before an initial or beginning timestep of the Clifford circuit 110 and that changes the Clifford circuit 110 equivalently as

$${P}_{i}^{n}$$

changes the Clifford circuit 110.

Although the herein disclosure mainly describes various embodiments in which the detection component 118 backpropagates Pauli operators to a beginning, start, or front of the Clifford circuit 110, these are mere non-limiting examples. In other embodiments, the detection component 118 can instead propagate Pauli operators to any other timestep of the Clifford circuit 110 (e.g., to an end of the Clifford circuit 110, to some intermediate timestep in the Clifford circuit 110). As long as the detection component 118 propagates different Pauli operators to the same circuit timestep as each other, various embodiments can function as intended or described.

In various instances, the detection component 118 can compute a respective backpropagation for each of the set of Pauli operators 304 (note that C_{before} and C_{after} can be different for different ones of the set of Pauli operators 304), thereby yielding a plurality of backpropagations. In various cases, if a multiplicative product of that plurality of backpropagations satisfies any suitable error mitigation criterion, the set of Pauli operators 304 can be considered as forming a valid generalized Pauli check. In other words, if

$${\prod }_{i = 1}^{k} B ( {P}_{i}^{n} )$$

satisfies the error mitigation criterion, then the generalized Pauli check 302 can be considered as properly or validly able to detect errors during performance of the Clifford circuit 110.

In some embodiments, the error mitigation criterion can be equality to an n-qubit identity operator. That is, the generalized Pauli check 302 can be considered as properly or validly able to detect errors during performance of the Clifford circuit 110 if

$${\prod }_{i = 1}^{k} B ( {P}_{i}^{n} ) = {I}^{n} ,$$

where Iⁿ is a 2ⁿ×2ⁿ identity matrix.

In other embodiments, the error mitigation criterion can instead be equality to the backpropagation of one or more other Pauli operators that are randomly-inserted by the detection component 118 into the Clifford circuit 110. In particular, suppose that the detection component 118 randomly inserts a total of q weight-1, non-identity, n-qubit Pauli operators into the Clifford circuit 110 for any suitable positive integer q (e.g., the detection component 118 can randomly select which data qubits and which circuit timesteps those q randomly-inserted Paulis operate on). Note that such q randomly-inserted Pauli operators are distinct from the Pauli operators that make up the set of generalized Pauli checks 202. In such case, the generalized Pauli check 302 can be considered as properly or validly able to detect errors during performance of the Clifford circuit 110 if

$${\prod }_{i = 1}^{k} B ( {P}_{i}^{n} ) = {\prod }_{j = 1}^{q} B ( {P}_{random j}^{n} ) ,$$

where

$${\prod }_{j = 1}^{q} B ( {P}_{random j}^{n} )$$

represents the multiplicative product of the backpropagations of the q randomly-inserted Pauli operators. In other words, it is possible for the generalized Pauli check 302 to be valid or otherwise efficacious, even if

$${\prod }_{i = 1}^{k} B ( {P}_{i}^{n} ) \neq {I}^{n} .$$

In still other embodiments, the error mitigation criterion can instead be membership of or presence in a stabilizer group of the Clifford circuit 110 (e.g., membership of or presence in a mathematical group of unitary transformations that leave a quantum state associated with the Clifford circuit 110 unchanged). Specifically, suppose that the Clifford circuit 110 has a stabilizer group denoted by S. In such case, the generalized Pauli check 302 can be considered as properly or validly able to detect errors during performance of the Clifford circuit 110 if

$${\prod }_{i = 1}^{k} B ( {P}_{i}^{n} ) ∈ S .$$

Again, this shows that it is possible for the generalized Pauli check 302 to be valid or otherwise efficacious, even if

$${\prod }_{i = 1}^{k} B ( {P}_{i}^{n} ) \neq {I}^{n} .$$

In some embodiments, the error mitigation criterion can involve both the stabilizer group associated with the Clifford circuit 110 and any weight-1, non-identity, n-qubit Pauli operators that are randomly-inserted into the Clifford circuit 110. In particular, suppose again that the detection component 118 randomly inserts a total of q weight-1, non-identity, n-qubit Pauli operators into the Clifford circuit 110 (again, such q operators are distinct from those that make up the set of generalized Pauli checks 202), and also suppose that the Clifford circuit 110 has a stabilizer group denoted by S. In such case, the generalized Pauli check 302 can be considered as properly or validly able to detect errors during performance of the Clifford circuit 110 if

$$( {\prod }_{j = 1}^{q} B ( {P}_{random j}^{n} ) ) ( {\prod }_{i = 1}^{k} B ( {P}_{i}^{n} ) ) ∈ S .$$

Once again, this shows that it is possible for the generalized Pauli check 302 to be valid or otherwise efficacious, even if

$${\prod }_{i = 1}^{k} B ( {P}_{i}^{n} ) \neq {I}^{n} .$$

In any case, the generalized Pauli check 302 can function as a proper or appropriate check for the Clifford circuit 110, if the product of backpropagations of the set of Pauli operators 304 satisfies the error mitigation criterion.

In various aspects, each of the set of generalized Pauli checks 202 can be constructed or designed like the generalized Pauli check 302. That is, each of the set of generalized Pauli checks 202 can be composed of one or more weight-1, n-qubit Pauli operators that are inserted into or throughout the Clifford circuit 110 so that the product of backpropagations of those one or more weight-1, n-qubit Pauli operators satisfies the error mitigation criterion. Note that different ones of the set of generalized Pauli checks 202 can be made of the same or different numbers, types, or arrangements of weight-1, n-qubit Pauli operators as each other.

In various embodiments, the detection component 118 can electronically execute the Clifford circuit 110 and the set of generalized Pauli checks 202 on the quantum computer 104. That is, the detection component 118 can initialize the states of the set of data qubits 106 and the set of check qubits 108 in any suitable fashion and can manipulate those initialized states according to quantum operations specified or otherwise called for by the Clifford circuit 110 and by the set of generalized Pauli checks 202. After such execution, the detection component 118 can electronically perform a respective quantum read or measurement operation on each of the set of data qubits 106 and on each of the set of check qubits 108.

If the read or measured states of all of the set of check qubits 108 indicate that no error has occurred during such execution (e.g., if each of the set of check qubits 108 is in the |0 [symbol] state after execution of the Clifford circuit 110 and the set of generalized Pauli checks 202), then the detection component 118 can conclude that the read or measured states of the set of data qubits 106 can be trusted. Accordingly, the detection component 118 can take any suitable follow-on electronic actions with respect to the read or measured states of the set of data qubits 106 (e.g., can electronically transmit or share the read or measured states of the set of data qubits 106 with any other suitable computing device; can electronically render the read or measured states of the set of data qubits 106 on any suitable computer screen or monitor associated with the quantum computer 104).

On the other hand, if the read or measured state of any of the set of check qubits 108 indicates that an error has occurred during such execution (e.g., if at least one of the set of check qubits 108 is in the |1 [symbol] state after execution of the Clifford circuit 110 and the set of generalized Pauli checks 202), then the detection component 118 can conclude that the read or measured states of the set of data qubits 106 cannot be trusted. Accordingly, the detection component 118 can reinitialize the states of the set of data qubits 106 and of the set of check qubits 108 and can re-execute the Clifford circuit 110 and the set of generalized Pauli checks 202 until all of the set of check qubits 108 indicate no error. In other words, the detection component 118 can post-select on the set of check qubits 108 all indicating that no error has occurred during performance of the Clifford circuit 110.

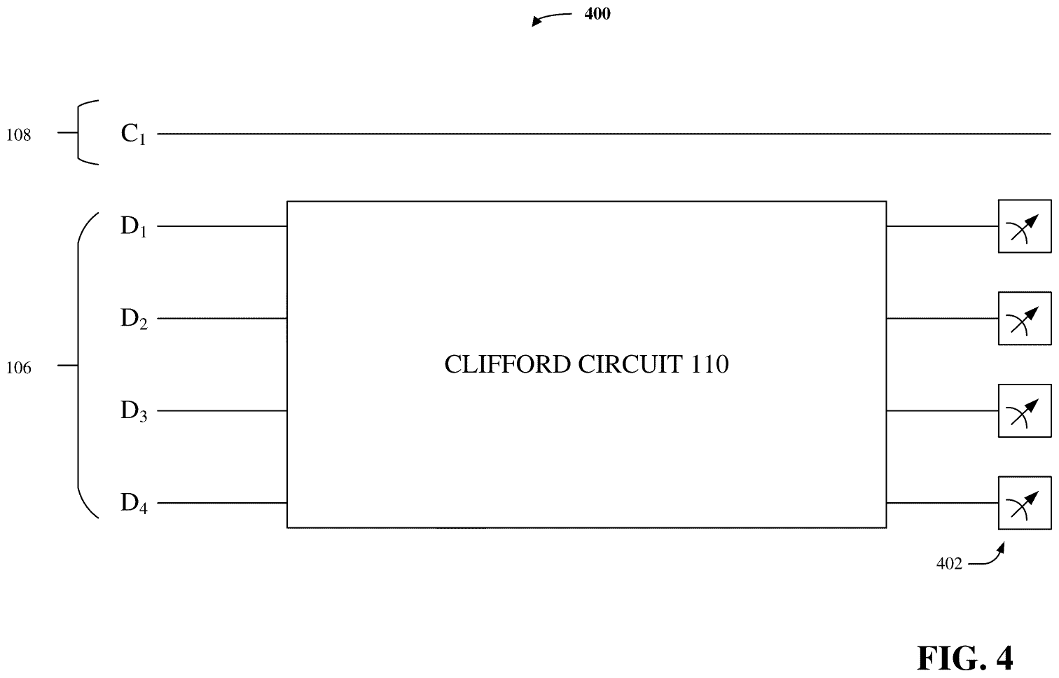

FIGS. 4-6 illustrate example, non-limiting circuit diagrams 400, 500, and 600 regarding the generalized Pauli check 302 in accordance with one or more embodiments described herein.

In the non-limiting examples of FIGS. 4-6, the set of data qubits 106 has a total of four data qubits denoted by shorthand notation (e.g., “D₁” represents a first data qubit of the set of data qubits 106; “D₂” represents a second data qubit of the set of data qubits 106). Likewise, in the non-limiting examples of FIGS. 4-6, the set of check qubits 108 has a total of one check qubit denoted by shorthand notation (e.g., “C₁” represents the first and only check qubit of the set of check qubits 108).

Although not explicitly shown in FIGS. 4-6, the detection component 118 can electronically initialize the set of data qubits 106 and the set of check qubits 108 in any suitable fashion. As a non-limiting example, the detection component 118 can initialize each of the set of data qubits 106 and each of the set of check qubits 108 to |0 [symbol] .

First, consider FIG. 4. As shown, the Clifford circuit 110 can operate on the set of data qubits 106. It should be understood or otherwise appreciated that quantum circuit diagrams are read from left to right. Accordingly, after the Clifford circuit 110 is executed, the resultant quantum states of the set of data qubits 106 can be read or measured, as indicated by numeral 402.

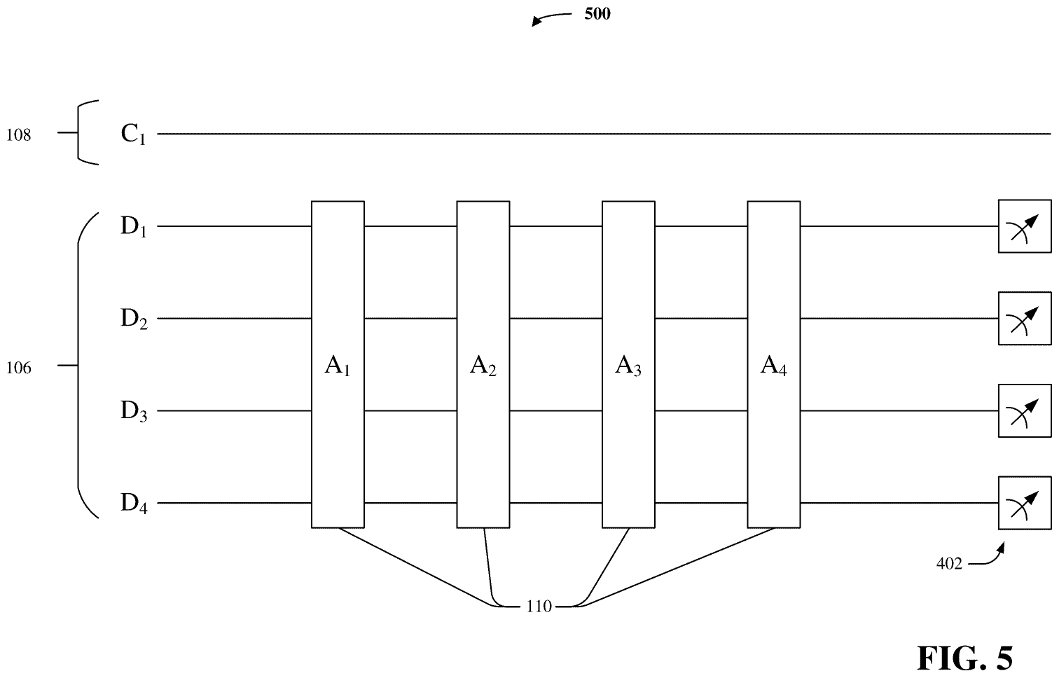

Now, consider FIG. 5. In various aspects, the Clifford circuit 110 can be considered as a sequence of any suitable or desirable number of smaller or shorter subcircuits. In the non-limiting example of FIG. 5, the Clifford circuit 110 is broken up into a sequence of four subcircuits: a first subcircuit denoted by “A₁”; a second subcircuit denoted by “A₂”; a third subcircuit denoted by “A₃”; and a fourth subcircuit denoted by “A₄”. As a non-limiting example, suppose that the Clifford circuit 110 is a sequence having a total of h n-qubit operators, for any suitable positive integer h. In such case, A₁ can be considered as the subcircuit formed by the first consecutive h₁ of those h total n-qubit operators, A₂ can be considered as the subcircuit formed by whatever consecutive h₂ of those h total n-qubit operators follow A₁, A₃ can be considered as the subcircuit formed by whatever consecutive h₃ of those h total n-qubit operators follow A₂, and A₄ can be considered as the subcircuit formed by the last consecutive h₄ of those h total n-qubit operators, for any suitable positive integers h₁, h₂, h₃, and h₄ where h₁+h₂+h₃+h₄=h. Accordingly, in linear algebra notation, the Clifford circuit 110 can be considered as being equal to A₄A₃A₂A₁. Note that A₁, A₂, A₃, and A₄ need not satisfy any special restrictions or constraints, other than that the matrix multiplication product A₄₄₃₄₂₄₁ be equal to the Clifford circuit 110.

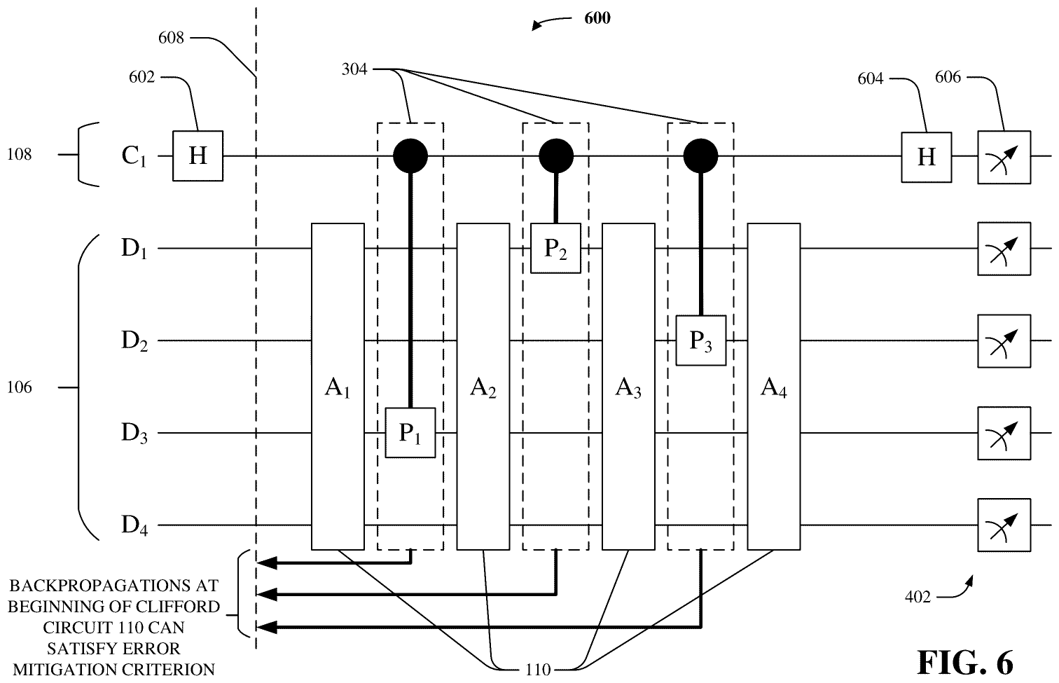

Next, consider FIG. 6, which illustrates an example, non-limiting embodiment of the set of Pauli operators 304, and thus of the generalized Pauli check 302, being controlled by C₁. In the non-limiting example of FIG. 6, the set of Pauli operators 304 has a total of three operators. That is, k=3 in the circuit diagram 600. Specifically, a first Pauli operator of the set of Pauli operators 304 is designated by “P₁” and is located at a circuit timestep in between A₁ and A₂. Moreover, a second Pauli operator of the set of Pauli operators 304 is designated by “P₂” and is located at a circuit timestep in between A₂ and A₃. Lastly, a third Pauli operator of the set of Pauli operators 304 is designated by “P₃” and is located at a circuit timestep in between A₃ and A₄. Each of those three Pauli operators can be considered as an n-qubit operator that is obtained via the tensor product between a respective 1-qubit, non-identity Pauli gate and 3 copies of the 1-qubit identity gate. In particular, P₁ is illustrated as having a: a 1-qubit identity gate operating on D₁; a 1-qubit identity gate operating on D₂; a non-identity, 1-qubit Pauli gate operating on D₃; and a 1-qubit identity gate operating on D₄. Furthermore, P₂ is illustrated as having a: a non-identity, 1-qubit Pauli gate operating on D₁; a 1-qubit identity gate operating on D₂; a 1-qubit identity gate operating on D₃; and a 1-qubit identity gate operating on D₄. Further still, P₃ is illustrated as having a: a 1-qubit identity gate operating on D₁; a 1-qubit, non-identity Pauli gate operating on D₂; a 1-qubit identity gate operating on D₃; and a 1-qubit identity gate operating on D₄. Note how all three of the set of P₁, P₂, and P₃ are controlled by C₁ (e.g., have C₁ as a source qubit).

Now, in order for the set of Pauli operators 304, and thus the generalized Pauli check 302, to function as described herein, they can be selected such the product of their backpropagations to the beginning or front of the Clifford circuit 110 satisfy the error mitigation criterion. Numeral 608 can be considered as depicting the beginning or front of the Clifford circuit 110. Using the above-described backpropagation formulation, the backpropagation of P₁ can be equal to

$${C}_{before , 1}^{†} {P}_{1} {C}_{before , 1} ,$$

where C_{before,1} can be whatever quantum gates of the Clifford circuit 110 come before P₁. Since only A₁ comes before P₁ in the non-limiting example of FIG. 6, the backpropagation of P₁ can be equal to

$${A}_{1}^{†} {P}_{1} {A}_{1} .$$

Similarly, using the above-described backpropagation formulation, the backpropagation of P₂ can be equal to

$${C}_{before , 2}^{†} {P}_{2} {C}_{before , 2} ,$$

where C_{before,2} can be whatever quantum gates of the Clifford circuit 110 come before P₂. Since both A₁ and A₂ come before P₂ in the non-limiting example of FIG. 6, the backpropagation of P₂ can be equal to (A₂A₁)+P₂ (A₂A₁). Likewise, using the above-described backpropagation formulation, the backpropagation of P₃ can be equal to

$${C}_{before , 3}^{†} {P}_{3} {C}_{before , 3} ,$$

where C_{before,3} can be whatever quantum gates of the Clifford circuit 110 come before P₃. Since A₁, A₂, and A₃ come before P₃ in the non-limiting example of FIG. 6, the backpropagation of P₃ can be equal to (A₃A₂A₁)†P₃ (A₃A₂A₁). Note how, when computing the backpropagation of any given one of the set of Pauli operators 304, the remaining ones of the set of Pauli operators 304 (e.g., the other Paulis that have been inserted inside of the Clifford circuit 110) can be ignored or not considered, due to the fact that global phase can be ignored. In any case, the multiplicative product of the backpropagations of the set of Pauli operators 304 shown in the non-limiting example of FIG. 6 can be:

$$[ {( {A}_{3} {A}_{2} {A}_{1} )}^{†} {P}_{3} ( {A}_{3} {A}_{2} {A}_{1} ) ] [ {( {A}_{2} {A}_{1} )}^{†} {P}_{2} ( {A}_{2} {A}_{1} ) ] [ {A}_{1}^{†} {P}_{1} {A}_{1} ]$$

If that multiplicative product satisfies the error mitigation criterion (e.g., if that multiplicative product is equal to the n-qubit identity operator when global phase is ignored; if that multiplicative product is equal to the product of backpropagations of q randomly-inserted Pauli operators (not shown in FIG. 6), or if that multiplicative product is an element of the stabilizer group of the Clifford circuit 110), then the generalized Pauli check 302 can be considered as a properly functioning check of the Clifford circuit 110. As further explained later herein, the detection component 118 can utilize any suitable mathematical or searching techniques so as to ensure that such multiplicative product satisfies the error mitigation criterion.

In various aspects, as shown by numeral 602, a Hadamard gate can be applied to C₁ prior to (e.g., upstream of) the beginning or front of the Clifford circuit 110. Conversely, as shown by numeral 604, a Hadamard gate can be applied to C₁ following (e.g., downstream of) an end or tail of the Clifford circuit 110. In various instances, such Hadamard gates can be considered as placing C₁ into an X-basis for measurement. It should be appreciated that any of such Hadamard gates can be accompanied by Phase gates as appropriate or desired (e.g., so as to take phase into account or so as to ignore phase). After execution of the set of Pauli operators 304 (and of any Hadamard or Phase gates, if applicable), the resultant quantum state of C₁ can be read or measured, as indicated by numeral 606. Suppose that C₁ is initialized in the |0 [symbol] state. In such case, if the read or measured state of C₁ is |0 [symbol] , then this can be interpreted to mean that no error occurred (or that an undetected error occurred) during performance of the Clifford circuit 110, and so the read or measured states of D₁, D₂, D₃, and D₄ can thus be trusted. Accordingly, the detection component 118 can share or display the read or measured states of D₁, D₂, D₃, and D₄. In contrast, if the read or measured state of C₁ is |1 [symbol] , then this can be interpreted to mean that an error occurred during performance of the Clifford circuit 110, and so the read or measured states of D₁, D₂, D₃, and D₄ can thus not be trusted. Accordingly, the detection component 118 can re-initialize the states of C₁, D₁, D₂, D₃, and D₄ and can re-execute the Clifford circuit 110 and the set of Pauli operators 304. The detection component 118 can repeat such actions until the post-execution state of C₁ is |0 [symbol] .

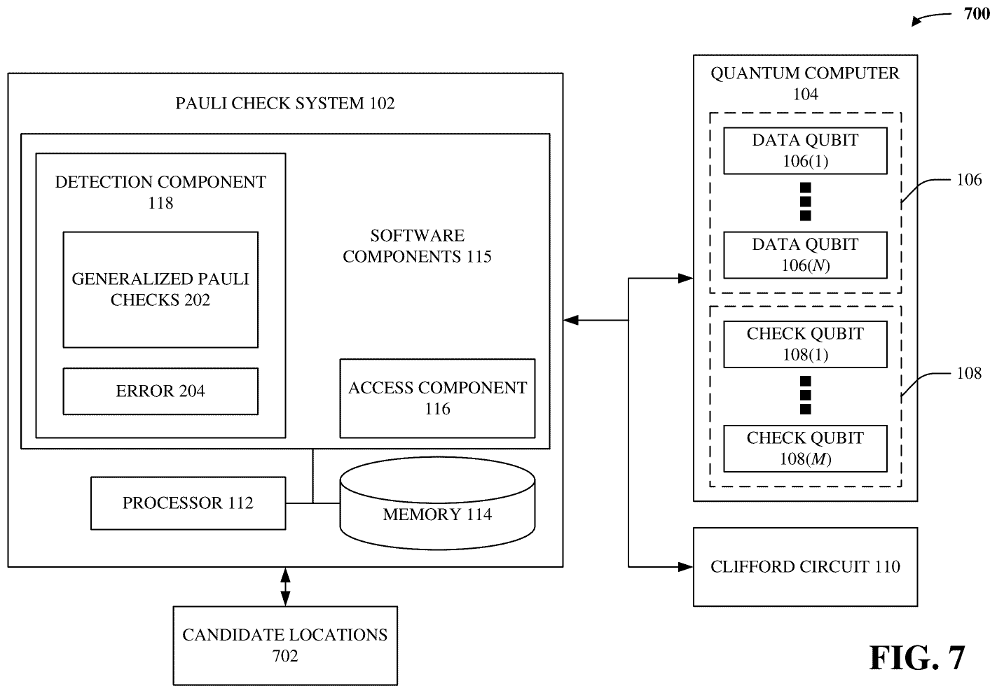

FIG. 7 illustrates a block diagram of an example, non-limiting system 700 including a plurality of candidate locations that can facilitate error mitigation for Clifford circuits via generalized Pauli checks in accordance with one or more embodiments described herein. As shown, the system 700 can, in some cases, comprise the same components as the system 200, and can further comprise a plurality of candidate locations 702.

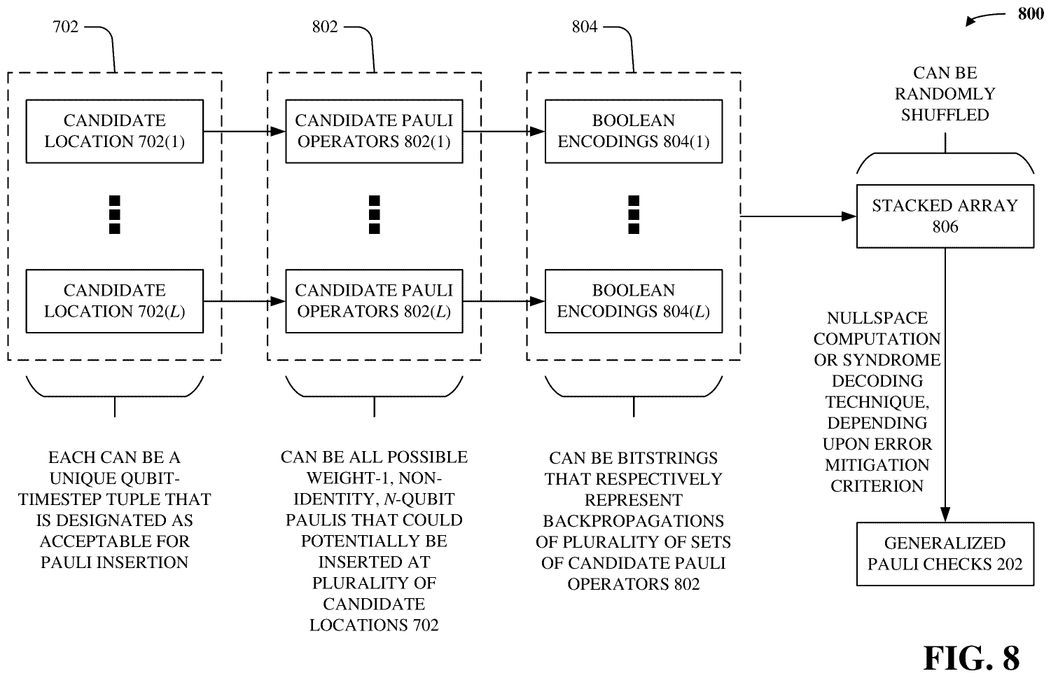

In various embodiments, the access component 116 can electronically receive, electronically retrieve, electronically import, electronically obtain, or otherwise electronically access the plurality of candidate locations 702 in any suitable fashion from any suitable electronic database or data structure. As a non-limiting example, the plurality of candidate locations 702 can be electronic data that is provided to the access component 116 by a user or technician associated with the quantum computer 104. Indeed, such user or technician can provide, create, select, or denote the plurality of candidate locations 702 by interacting with any suitable human-computer interface device, such as a keyboard, a keypad, a touchscreen, a joystick, or a voice control system. In any case, the detection component 118 can electronically determine or identify the set of generalized Pauli checks 202 based on the plurality of candidate locations 702. In other words, the detection component 118 can leverage the plurality of candidate locations 702 so as to determine which weight-1, n-qubit, non-identity Pauli operators to insert where in the Clifford circuit 110 so that their backpropagations satisfy the error mitigation criterion. Various non-limiting aspects are described with respect to FIG. 8.

FIG. 8 illustrates an example, non-limiting block diagram 800 showing how the set of generalized Pauli checks 202 can be obtained or identified for the Clifford circuit 110 when given the plurality of candidate locations 702 in accordance with one or more embodiments described herein.

In various embodiments, the plurality of candidate locations 702 can comprise/locations, for any suitable positive integer l>1: a candidate location 702(1) to a candidate location 702(l). In various aspects, each of the plurality of candidate locations 702 can be any suitable electronic data (e.g., one or more scalars, one or more vectors, one or more matrices, one or more tensors, one or more character strings, or any suitable combination thereof) that can indicate or otherwise represent a respective qubit-timestep tuple within the Clifford circuit 110 that is deemed or designated as a suitable or acceptable location for insertion of a weight-1, n-qubit, non-identity Pauli operator. As a non-limiting example, the candidate location 702(1) can be a first scalar, vector, matrix, tensor, or character string that specifies a first circuit timestep of the Clifford circuit 110 at which any suitable weight-1, n-qubit, non-identity Pauli operator could potentially or possibly be inserted for a first one of the set of data qubits 106. As another non-limiting example, the candidate location 702(1) can be an l-th scalar, vector, matrix, tensor, or character string that specifies an l-th circuit timestep of the Clifford circuit 110 at which any suitable weight-1, n-qubit, non-identity Pauli operator could potentially or possibly be inserted for an l-th one of the set of data qubits 106. Note that different ones of the plurality of candidate locations 702 can indicate the same or different qubits as each other or the same or different circuit timesteps as each. However, in various cases, no two of the plurality of candidate locations 702 can indicate both the same qubit and the same circuit timestep as each other.

Now, in various aspects, the plurality of candidate locations 702 can be considered as respectively corresponding to a plurality of sets of candidate Pauli operators 802, with each of the plurality of sets of candidate Pauli operators 802 indicating all possible weight-1, n-qubit, non-identity Pauli operators that could be inserted or placed at a respective one of the plurality of candidate locations 702.

As a non-limiting example, the candidate location 702(1) can correspond to a set of candidate Pauli operators 802(1). Accordingly, the set of candidate Pauli operators 802(1) can be considered as the set of all possible weight-1, n-qubit, non-identity Pauli operators that could be inserted or placed at the candidate location 702(1). More specifically, the set of candidate Pauli operators 802(1) can include three candidate Pauli operators. A first candidate Pauli operator of the set of candidate Pauli operators 802(1) can be the n-qubit matrix that is obtained via the tensor product between: a 2×2 Pauli-X gate applied at whichever one of the set of data qubits 106 is indicated by the candidate location 702(1); and n−1 copies of the 2×2 identity matrix applied at the remainder of the set of data qubits 106. A second candidate Pauli operator of the set of candidate Pauli operators 802(1) can be the n-qubit matrix that is obtained via the tensor product between: a 2×2 Pauli-Y gate applied at whichever one of the set of data qubits 106 is indicated by the candidate location 702(1); and n−1 copies of the 2×2 identity matrix applied at the remainder of the set of data qubits 106. A third candidate Pauli operator of the set of candidate Pauli operators 802(1) can be the n-qubit matrix that is obtained via the tensor product between: a 2×2 Pauli-Z gate applied at whichever one of the set of data qubits 106 is indicated by the candidate location 702(1); and n−1 copies of the 2×2 identity matrix applied at the remainder of the set of data qubits 106.

As another non-limiting example, the candidate location 702(l) can correspond to a set of candidate Pauli operators 802(l). Accordingly, the set of candidate Pauli operators 802(1) can be considered as the set of all possible weight-1, n-qubit, non-identity Pauli operators that could be inserted or placed at the candidate location 702(l). More specifically, the set of candidate Pauli operators 802(l) can include three candidate Pauli operators. A first candidate Pauli operator of the set of candidate Pauli operators 802(1) can be the n-qubit matrix that is obtained via the tensor product between: a 2×2 Pauli-X gate applied at whichever one of the set of data qubits 106 is indicated by the candidate location 702(1); and n−1 copies of the 2×2 identity matrix applied at the remainder of the set of data qubits 106. A second candidate Pauli operator of the set of candidate Pauli operators 802(1) can be the n-qubit matrix that is obtained via the tensor product between: a 2×2 Pauli-Y gate applied at whichever one of the set of data qubits 106 is indicated by the candidate location 702(l); and n−1 copies of the 2×2 identity matrix applied at the remainder of the set of data qubits 106. A third candidate Pauli operator of the set of candidate Pauli operators 802(l) can be the n-qubit matrix that is obtained via the tensor product between: a 2×2 Pauli-Z gate applied at whichever one of the set of data qubits 106 is indicated by the candidate location 702(1); and n−1 copies of the 2×2 identity matrix applied at the remainder of the set of data qubits 106.

In various aspects, the detection component 118 can electronically convert a respective backpropagation of each candidate Pauli operator of the plurality of sets of candidate Pauli operators 802 into a respective Boolean encoding (e.g., a respective bitstring representation), thereby yielding a plurality of sets of Boolean encodings 804. As a non-limiting example, the detection component 118 can electronically compute backpropagations for each of the set of candidate Pauli operators 802(1) and can convert those backpropagations into a set of Boolean encodings 804(1). In other words, the set of Boolean encodings 804(1) can include or possess three distinct bitstrings, each representing a backpropagation of a respective one of the three distinct candidate Pauli operators that are included in the set of candidate Pauli operators 802(1). As another non-limiting example, the detection component 118 can electronically compute backpropagations for each of the set of candidate Pauli operators 802(l) and can convert those backpropagations into a set of Boolean encodings 804(l). That is, the set of Boolean encodings 804(1) can include or possess three distinct bitstrings, each representing a backpropagation of a respective one of the three distinct candidate Pauli operators that are included in the set of candidate Pauli operators 802(1).

In various instances, the detection component 118 can electronically stack the plurality of sets of Boolean encodings 804 on top of each other. In various cases, such stacking can yield a stacked array 806. Thus, the stacked array 806 can be a considered as a stack or tower of bitstrings having a total height of 3/(e.g., there can be/total candidate locations, and each candidate location can be associated with three possible or candidate weight-1, n-qubit, non-identity Pauli operators). In other words, each row of the stacked array 806 can be considered as representing in binary format the backpropagation of a respective candidate Pauli operator from the plurality of sets of candidate Pauli operators 802. In some aspects, the detection component 118 can electronically shuffle or otherwise randomly organize the rows of the stacked array 806.

In various aspects, the detection component 118 can electronically analyze the stacked array 806 via any suitable linear algebra or other mathematical techniques. In various instances, the end result of such analysis can be identification or determination of the set of generalized Pauli checks 202. In various cases, how the detection component 118 analyzes the stacked array 806 can depend upon the error mitigation criterion.

As a non-limiting example, suppose that the error mitigation criterion is that the product of backpropagations is equal to an identity operator (up to a global phase). In such case, the detection component 118 can compute a nullspace of the stacked array 806, and that nullspace can be considered as indicating the set of generalized Pauli checks 202. More specifically, computation of the nullspace of the stacked array 806 can be considered as determining which specific combinations of rows of the stacked array sum to an all-zero bitstring. Each of those identified combinations of rows can be considered as a representing a respective combination of candidate Pauli operators specified in the plurality of sets of candidate Pauli operators 802, and each of those combinations of candidate Pauli operators can be considered as a respective one of the set of generalized Pauli checks 202.

As another non-limiting example, suppose that the error mitigation criterion is that the product of backpropagations is equal to the product of backpropagations of q random Pauli operators that have also been inserted into the Clifford circuit 110 by the detection component 118. In such case, the detection component 118 can apply to the stacked array 806 any suitable syndrome decoding techniques or heuristic searching algorithms, whether greedy or non-greedy. Some non-limiting examples can include any suitable techniques that involve syndrome calculations, parity-check matrices, or the Berlekamp-Massey algorithm. In any case, application of such syndrome decoding techniques or heuristic searching algorithms can be considered as determining which specific combinations of rows of the stacked array sum to a bitstring that matches that which represents the product of backpropagations of the q randomly-inserted Pauli operators. Each of those identified combinations of rows can be considered as a representing a respective combination of candidate Pauli operators specified in the plurality of sets of candidate Pauli operators 802, and each of those combinations of candidate Pauli operators can be considered as a respective one of the set of generalized Pauli checks 202.

As yet another non-limiting example, suppose that the error mitigation criterion is that the product of backpropagations is an element of the stabilizer group of the Clifford circuit 110. In such case, the detection component 118 can apply to the stacked array 806 any suitable syndrome decoding techniques or heuristic searching algorithms, whether greedy or non-greedy, where application of such syndrome decoding techniques or heuristic searching algorithms can be considered as determining which specific combinations of rows of the stacked array sum to a bitstring that matches any bitstring that is known to represent an element of the stabilizer group. Each of those identified combinations of rows can be considered as a representing a respective combination of candidate Pauli operators specified in the plurality of sets of candidate Pauli operators 802, and each of those combinations of candidate Pauli operators can be considered as a respective one of the set of generalized Pauli checks 202.

In some cases, analysis of the stacked array 806 can be formulated as a linear algebra optimization problem. As a non-limiting example, such formulation can be given by:

$${min}_{x , y} \vert x \vert ∋ xF = q + y S$$

where x represents a selection of candidate Pauli operators whose weight is to be minimized, where Boolean matrix F represents the Boolean encodings of the backpropagations of candidate Pauli operators, where q represents one or more randomly-inserted Pauli operators that are to be implemented as a combination of backpropagated candidate Pauli operators, where y represents a combination of stabilizers, and where Boolean matrix S represents the stabilizer group of the Clifford circuit 110 at whatever timestep to which Pauli operators are being backpropagated. In some cases, the dependency on y can be eliminated by finding a nullspace Null of S. In such case, the above formulation simplifies to the following:

$${min}_{x} \vert x \vert ∋ xFNull = qNull$$

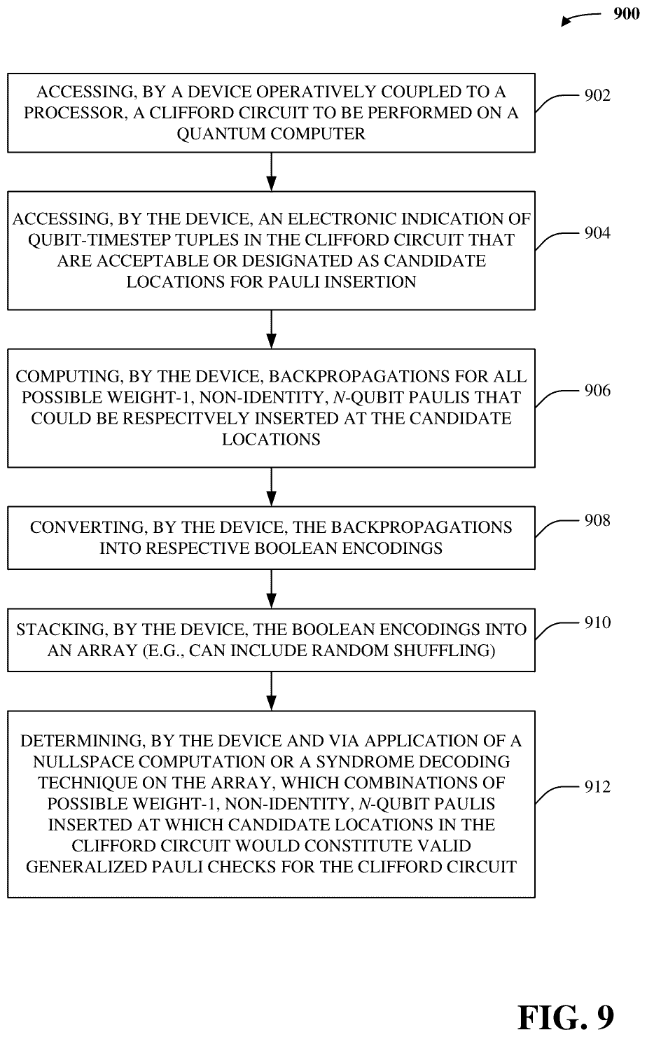

FIG. 9 illustrates a flow diagram of an example, non-limiting computer-implemented method 900 that can facilitate error mitigation for Clifford circuits via generalized Pauli checks in accordance with one or more embodiments described herein.

In various embodiments, act 902 can include accessing, by a device (e.g., via 116) operatively coupled to a processor (e.g., 112), a Clifford circuit (e.g., 110) to be performed on a quantum computer (e.g., 104).

In various aspects, act 904 can include accessing, by the device (e.g., via 116), an electronic indication of qubit-timestep tuples in the Clifford circuit that are acceptable or designated as candidate locations (e.g., 702) for Pauli insertion.

In various instances, act 906 can include computing, by the device (e.g., via 118), backpropagations for all possible weight-1, non-identity, n-qubit Paulis (e.g., 802) that could be respectively inserted at the candidate locations.

In various cases, act 908 can include converting, by the device (e.g., via 118), the backpropagations into respective Boolean encodings (e.g., 804).

In various aspects, act 910 can include stacking, by the device (e.g., via 118), the Boolean encodings into an array (e.g., 806). In some instances, this can involve randomly shuffling the rows of the array.

In various cases, act 912 can include determining, by the device (e.g., via 118) and via application of a nullspace computation or a syndrome decoding technique on the array, which combinations of possible weight-1, non-identity, n-qubit Paulis inserted at which candidate locations in the Clifford circuit would constitute valid generalized Pauli checks (e.g., 202) for the Clifford circuit.

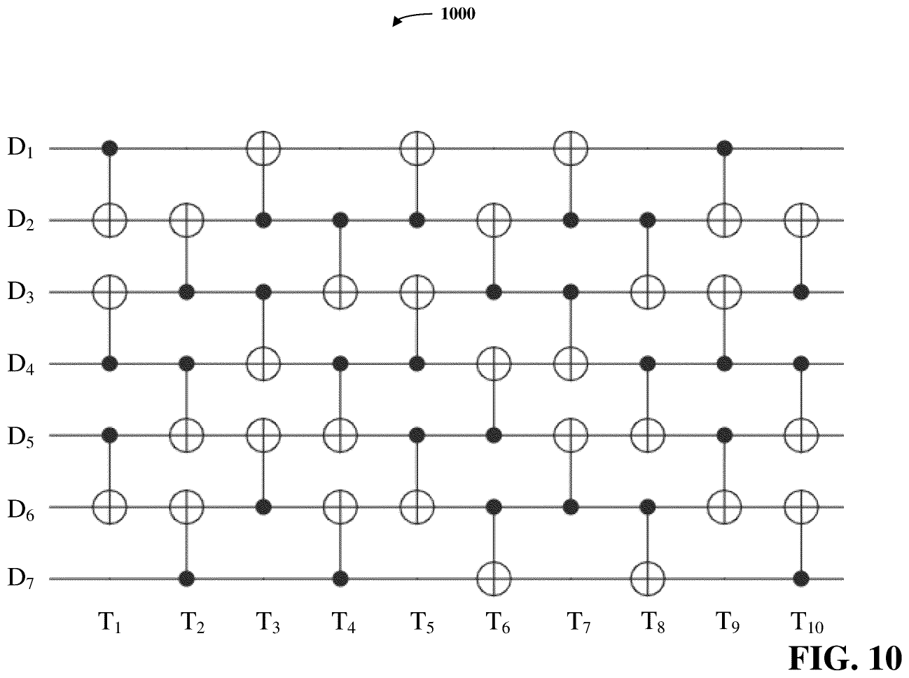

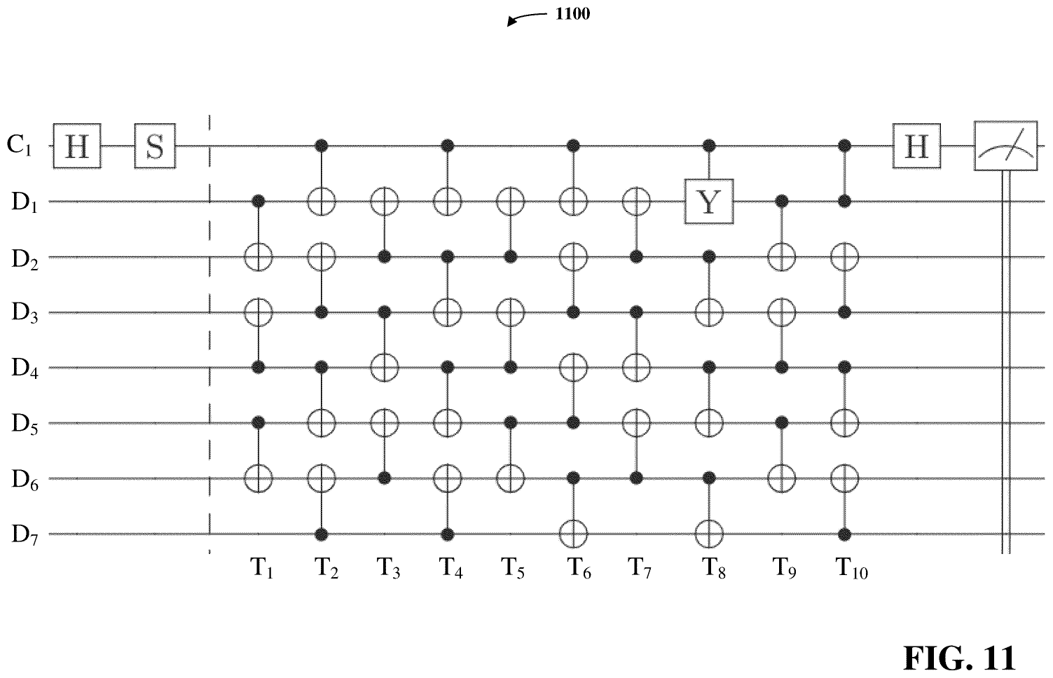

Various embodiments described herein can be considered as facilitating a new type of Pauli check for Clifford circuits (referred to herein as a generalized Pauli check) which does not have the stringent hardware constraints of two-sided Pauli checks. Indeed, a generalized Pauli check does not require any special coupling topology to be implemented, whereas a two-sided Pauli check requires an all-to-all coupling topology (or voluminous SWAP gates in the absence of an all-to-all coupling topology). In other words, no matter what coupling topology is implemented on the quantum computer 104, a valid generalized Pauli check can always be identified when given the Clifford circuit 110 and the set of candidate locations 702. In particular, the user or technician associated with the quantum computer 104 can cause the plurality of candidate locations 702 to specify or include only data qubits that are physically coupled to at least one check qubit. Equivalently, the set of check qubits 106 can be chosen from whatever qubits of the quantum computer 104 are unused by the Clifford circuit 110 and are coupled to at least one of the set of data qubits 106. So, a valid generalized Pauli check can be found for whatever topology the quantum computer 104 exhibits. Furthermore, a circuit depth of the Clifford circuit 110 can even be preserved in some situations, such as when the user or technician causes the set of candidate locations 702 to specify only “holes” in the Clifford circuit 110. Non-limiting aspects are described with respect to FIGS. 10-11.

FIGS. 10-11 illustrate example, non-limiting circuit diagrams 1000 and 1100 showing how a generalized Pauli check can work even for qubit topologies that have limited coupling in accordance with one or more embodiments described herein.

First, consider FIG. 10. In the non-limiting example of FIG. 10, a 7-qubit Clifford circuit (e.g., operating on a total of seven data qubits, from D₁ to D₇) composed of ten timesteps of CNOT gates is shown. Shorthand notation is used to denote circuit timestep in FIG. 10 (e.g., “T₁” denotes a first timestep of the 7-qubit Clifford circuit; “T₂” denotes a second timestep of the 7-qubit Clifford circuit; “T₃” denotes a third timestep of the 7-qubit Clifford circuit). Note the various visual holes (e.g., qubit-timestep tuples at which no quantum gate is applied) that are present in the circuit diagram 1000. As a non-limiting example, there are five holes on D₁: a first hole at T₂; a second hole at T₄; a third hole at T₆; a fourth hole at T₈; and a fifth hole at T₁₀. As another non-limiting example, there are five holes on D₇: a first hole at T₁; a second hole at T₃; a third hole at T₅; fourth hole at T₇; and a fifth hole at T₉.

Now, consider FIG. 11. In the non-limiting example of FIG. 11, there is only a single check qubit, denoted as C₁. Suppose that C₁ is coupled only to D₁ and to no other data qubits. In such a situation, a two-sided Pauli check could not be implemented without a vast number of interleaved SWAP gates, which would significantly increase the circuit depth of the Clifford circuit. In contrast, a valid generalized Pauli check can be found, notwithstanding that C₁ is coupled only to D₁. Indeed, as shown in the circuit diagram 1100, a valid generalized Pauli check that fills the five holes of D₁ is identified and inserted into the Clifford circuit: a CNOT gate controlled by C₁ and inserted at T₂; a CNOT gate controlled by C₁ and inserted at T₄; a CNOT gate controlled by C₁ and inserted at T₆; a Pauli-Y gate controlled by C₁ and inserted at T₈; and a Pauli-Z gate controlled by C₁ and inserted at T₁₀. That is, a two-sided Pauli check could not be implemented for the depicted Clifford circuit without significant cost in terms of circuit depth, but a valid generalized Pauli check is nevertheless able to be implemented, without even increasing the circuit depth at all in this particular non-limiting example. Note that, as shown, Hadamard gates and a Phase gate can be applied to C₁ for measurement basis purposes, as mentioned above.

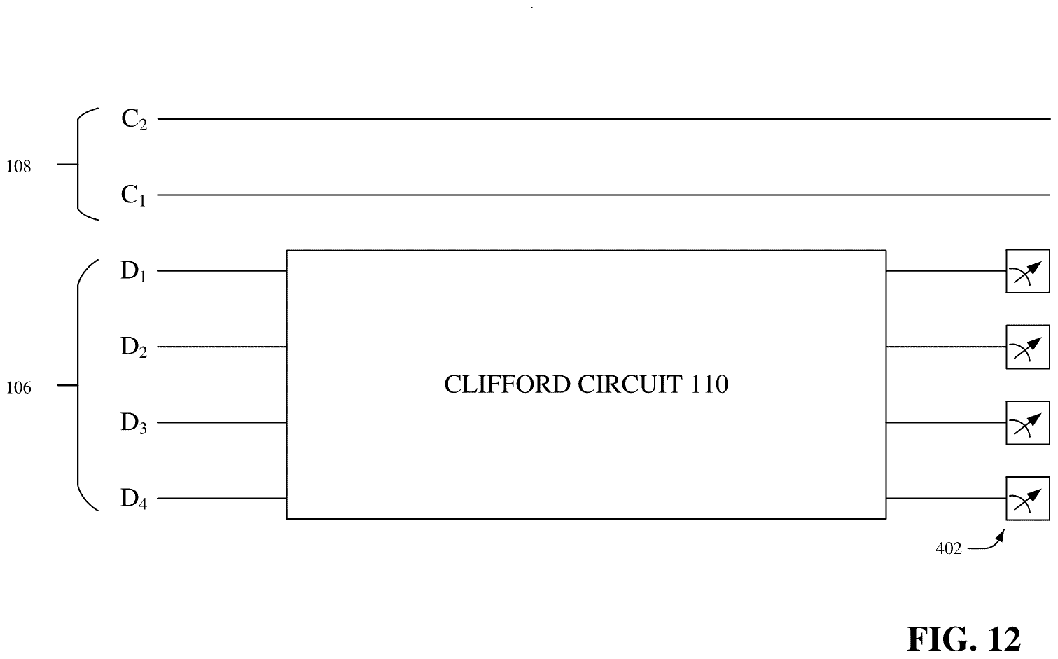

Thus far, various embodiments have been described that involve the Pauli operators of generalized Pauli checks being controlled by respective ones of the set of check qubits 108 and targeting respective ones of the set of data qubits 106. Indeed, in various aspects, the set of data qubits 106 can be whichever qubits of the quantum computer 104 that are utilized by the Clifford circuit 110, and the set of check qubits 108 can be whichever qubits of the quantum computer 104 that are not utilized by the Clifford circuit 110 and that are physically coupled to at least one of the set of data qubits 106. However, these are mere non-limiting examples. In some cases, one or more of the set of check qubits 108 need not be physically coupled to any of the set of data qubits 106, and yet such one or more of the set of check qubits 108 can nevertheless function or serve as proper or adequate sources for one or more respective ones of the set of generalized Pauli checks 202. In various aspects, this can be accomplished by daisy-chaining check qubits together. In other words, this can be accomplished when having a Pauli operator of one generalized Pauli check target or otherwise operate on a check qubit that controls the Pauli operators of some other generalized Pauli check. Non-limiting aspects are described with respect to FIGS. 12-14.

FIGS. 12-14 illustrate example, non-limiting circuit diagrams 1200, 1300, and 1400 showing how a generalized Pauli check can involve daisy-chained check qubits in accordance with one or more embodiments described herein.

First, consider FIG. 12. As shown, the circuit diagram 1200 can be like the circuit diagram 400, except that the set of check qubits 108 can comprise two qubits rather than one: C₁ and C₂. Suppose that C₂ is coupled only to C₁ and to none of D₁, D₂, D₃, or D₄.

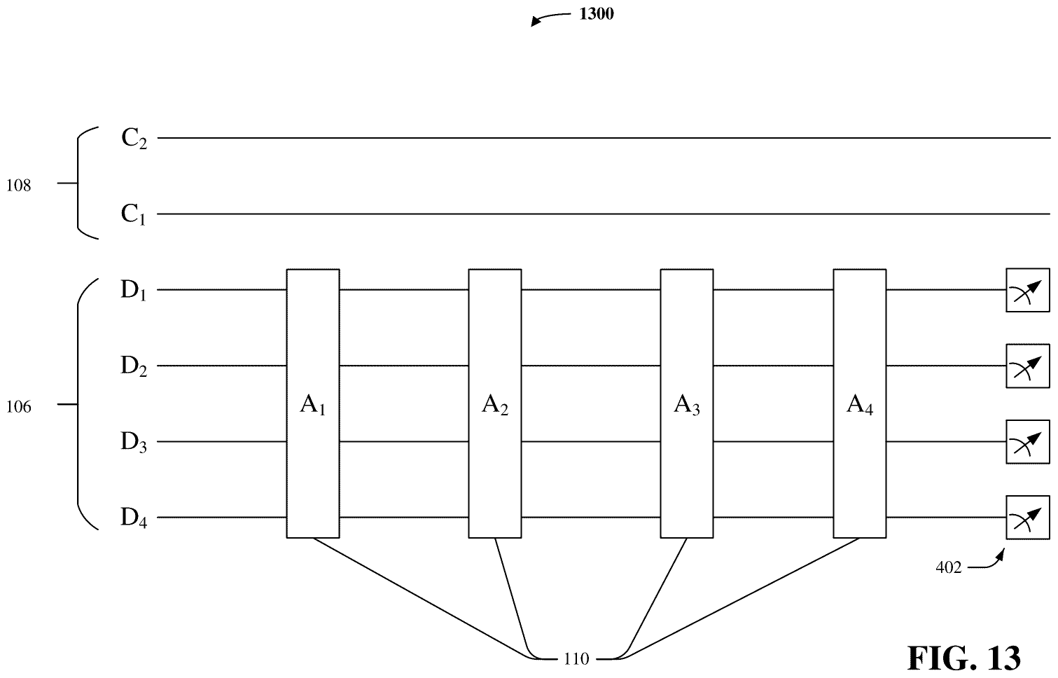

Next, consider FIG. 13. As shown, the circuit diagram 1300 can be like the circuit diagram 500, again with two check qubits instead of one.

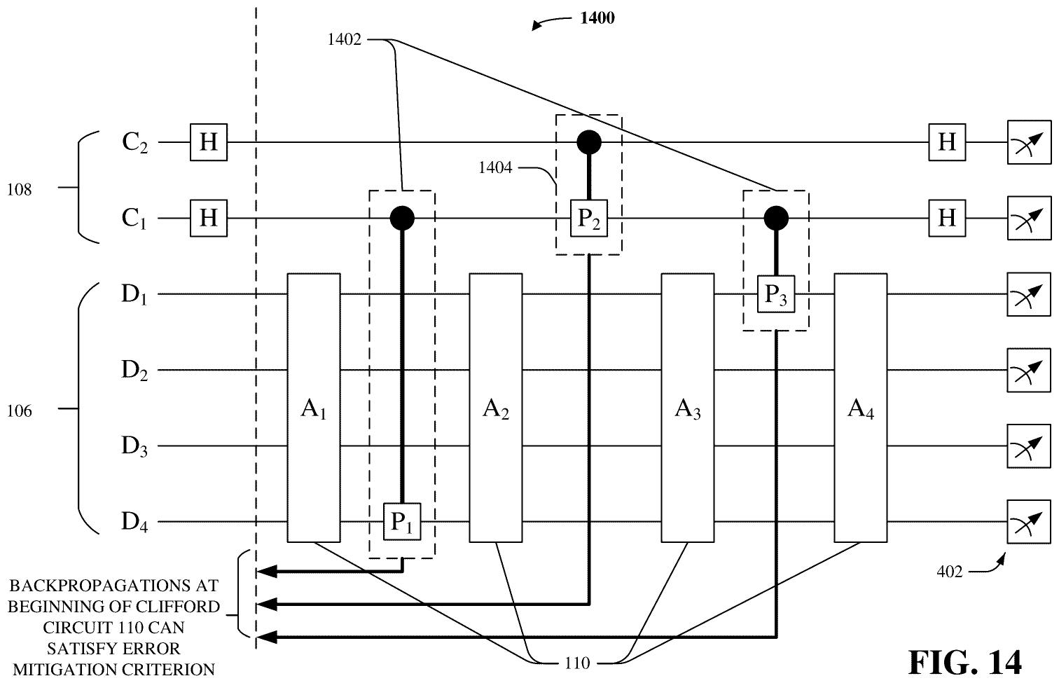

Now, consider FIG. 14. In various aspects, the circuit diagram 1400 depicts a non-limiting example of two generalized Pauli checks inserted into the Clifford circuit 110: a generalized Pauli check 1402 and a generalized Pauli check 1404. As shown, the generalized Pauli check 1402 can be controlled by C₁, whereas the generalized Pauli check 1404 can be controlled by C₂. In the non-limiting example of FIG. 14, the generalized Pauli check 1402 is made up of two Pauli operators: a first Pauli operator denoted by “P₁” and another Pauli operator denoted by “P₃”. In contrast, in the non-limiting example of FIG. 14, the generalized Pauli check 1404 is made up of only one Pauli operator denoted by “P₂”. Specifically, P₁ can be the tensor product obtained between: a 2×2 non-identity Pauli gate targeting D₄; and a 2×2 identity gate on each of D₁, D₂, and D₃. Additionally, P₃ can be the tensor product obtained between: a 2×2 non-identity Pauli gate targeting D₁; and a 2×2 identity gate on each of D₂, D₃, and D₄. In contrast, since C₂ is coupled only to C₁ in this non-limiting example, P₂ can be the tensor product obtained between: a 2×2 non-identity Pauli gate targeting C₁; and a 2×2 identity gate on each of D₁, D₂, D₃, and D₄. That is, P₁ and P₃ can be 4-qubit operators, but P₂ can instead be a 5-qubit operator. In other words, from the perspective of C₂, C₁ can be considered as a fifth or additional data qubit.

Now, from the above discussion of backpropagation, the generalized Pauli check 1402 can be selected or identified such that: [(A₃A₂A₁)†P₃(A₃A₂A₁)][A₁†P₁A₁] satisfies the error mitigation criterion. Also from the above discussion of backpropagation, the generalized Pauli check 1404 can be selected or identified such that:

$${( {A}_{2}^{*} {A}_{1}^{*} )}^{†} {P}_{2} ( {A}_{2}^{*} {A}_{1}^{*} )$$

satisfies the error mitigation criterion, where

$${A}_{1}^{*}$$

can be considered as the 5-qubit version of A₁ (e.g., tensor product between A₁ and a 2×2 identity gate), and where

$${A}_{2}^{*}$$

can be considered as the 5-qubit version of A₂ (e.g., tensor product between A₂ and a 2×2 identity gate). In this way, two valid generalized Pauli checks (e.g., 1402 and 1404) can be implemented on the Clifford circuit 110, notwithstanding that only a single check qubit (e.g., C₁) is coupled to the set of data qubits 106 in this non-limiting example. In other words, even though C₂ is not coupled to any of D₁, D₂, D₃, and D₄, C₂ can nevertheless be utilized to control a respective generalized Pauli check, by being daisy-chained onto or otherwise with respect to C₁. As shown, any suitable Hadamard gates can be implemented on C₁ and C₂ for measurement basis purposes.

More generally, whenever a new check qubit is daisy-chained in this fashion, the total data qubit count from the perspective of that new check qubit can be considered as being incremented (e.g., that new check qubit can target another check qubit, and so that new check qubit can treat as data qubits: all qubits that are treated as data qubits by that another check qubit; and that another check qubit itself). Such daisy-chaining is another concrete example of how generalized Pauli checks can be considered as having significantly relaxed hardware constraints as compared to two-sided Pauli checks.

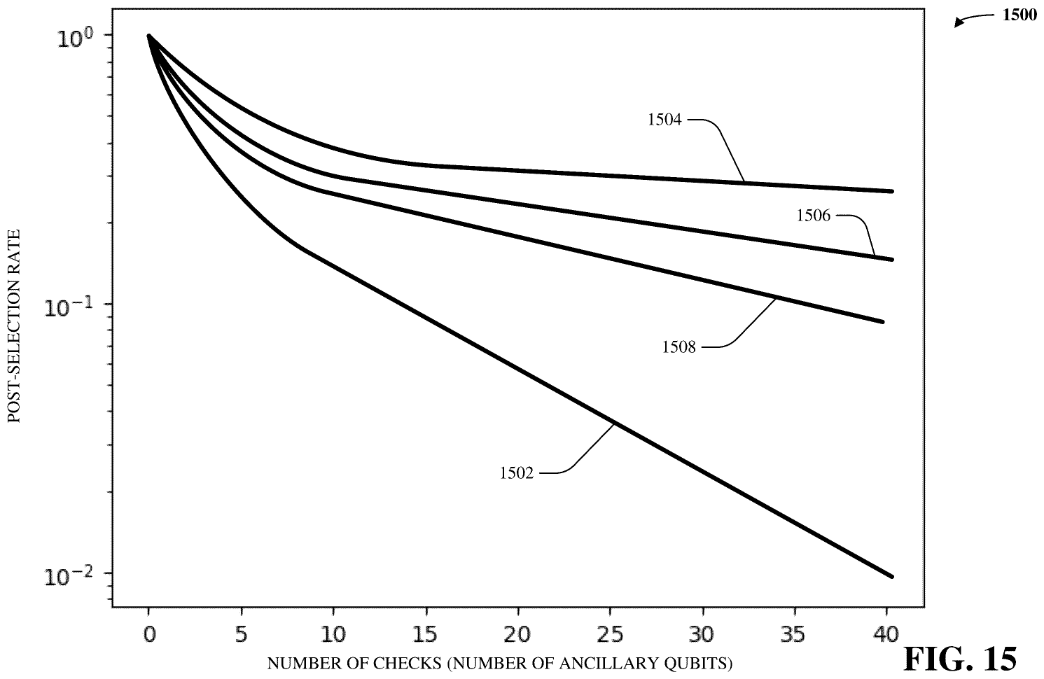

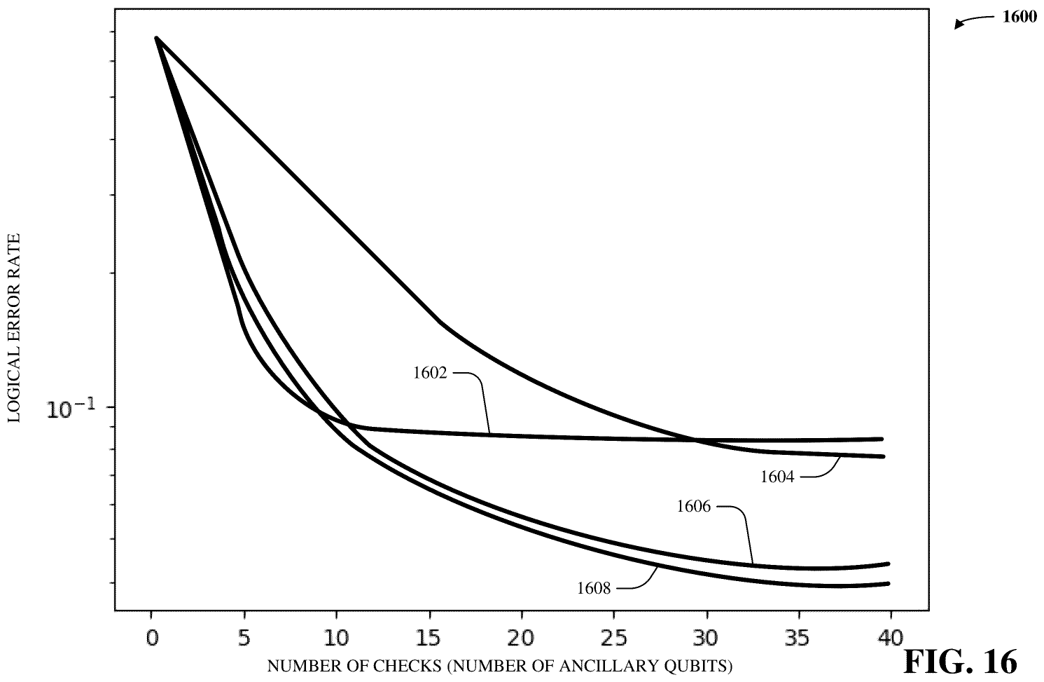

FIGS. 15-16 illustrate example, non-limiting experimental results in accordance with one or more embodiments described herein. In particular, the present inventors conducted various experiments regarding various embodiments described herein. Some of such experiments involved implementing various sets of generalized Pauli checks on randomly-generated, 20-qubit Clifford circuits performed on a linear nearest neighbor coupling topology (e.g., n=20). Such experiments treated state-of-the art sets of two-sided Pauli checks for those randomly generated Clifford circuits as baselines. Some results from those experiments are shown in FIGS. 15-16.

FIG. 15 shows a graph 1500 of post-selection rate as a function of number of Pauli checks (e.g., as a function of m). Numeral 1502 indicates the results exhibited by the two-sided Pauli check baselines. Numeral 1504 indicates the results exhibited by generalized Pauli checks that were each limited or restricted to being made up of two Pauli operators (e.g., k=2). Numeral 1506 indicates the results exhibited by generalized Pauli checks that were each limited or restricted to being made up of 10 Pauli operators (e.g., k=10). Numeral 1508 indicates the results exhibited by generalized Pauli checks that were each limited or restricted to being made up of 20 Pauli operators (e.g., k=20). As shown, all embodiments of the generalized Pauli checks exhibited significantly higher post-selection rates for all m as compared to the two-sided Pauli check baseline.

FIG. 16 shows a graph 1600 of logical error rate as a function of number of Pauli checks (e.g., as a function of m). Numeral 1602 indicates the results exhibited by the two-sided Pauli check baselines. Numeral 1604 indicates the results exhibited by generalized Pauli checks that were each limited or restricted to being made up of two Pauli operators (e.g., k=2). Numeral 1606 indicates the results exhibited by generalized Pauli checks that were each limited or restricted to being made up of 10 Pauli operators (e.g., k=10). Numeral 1608 indicates the results exhibited by generalized Pauli checks that were each limited or restricted to being made up of 20 Pauli operators (e.g., k=20). As shown, all embodiments of the generalized Pauli checks exhibited lower logical error rates than the two-sided Pauli check baseline for m>30. As also shown, generalized Pauli checks having larger numbers of constituent Pauli operators exhibited significantly lower logical error rates than the two-sided Pauli check baseline for m>10.

These experimental results demonstrate that generalized Pauli checks as described herein can achieve quantifiably better error mitigation as compared to two-sided Pauli checks. Similar results were experimentally obtained for random, 20-qubit Clifford circuits implemented on a caterpillar topology (e.g., where the body of the caterpillar made up the data qubits, and where the legs of the caterpillar made up the check qubits).

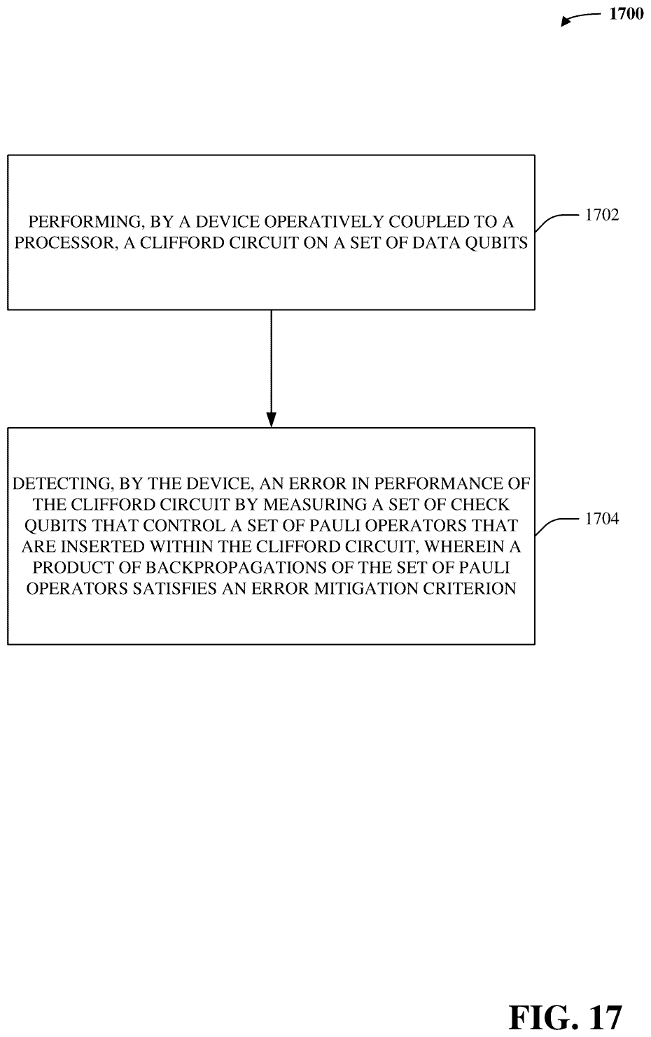

FIG. 17 illustrates a flow diagram of an example, non-limiting computer-implemented method 1700 that facilitates error mitigation for Clifford circuits via generalized Pauli checks in accordance with one or more embodiments described herein. In various cases, the Pauli check system 102 can facilitate the computer-implemented method 1700.

In various embodiments, act 1702 can include performing, by a device (e.g., via 116) operatively coupled to a processor (e.g., 112), a Clifford circuit (e.g., 110) on a set of data qubits (e.g., 106).

In various aspects, act 1704 can include detecting, by the device (e.g., 118), an error (e.g., 204) in performance of the Clifford circuit by measuring a set of check qubits (e.g., 108) that control a set of Pauli operators (e.g., that make up 202, such as how 304 make up 302) that are inserted within the Clifford circuit, wherein a product of backpropagations of the set of Pauli operators satisfies an error mitigation criterion.

Although not explicitly shown in FIG. 17, the device can identify the set of Pauli operators to be inserted within the Clifford circuit based on: computing, by the device (e.g., via 118), respective backpropagations for candidate Pauli operators (e.g., 804) associated with candidate locations (e.g., 802) in the Clifford circuit, thereby yielding a plurality of candidate backpropagations; stacking, by the device (e.g., via 118), respective Boolean encodings (e.g., 804) of the plurality of candidate backpropagations, thereby yielding a stacked array (e.g., 806); and computing, by the device (e.g., via 118), a nullspace of the stacked array.

Although not explicitly shown in FIG. 17, the device can compute the backpropagations of the set of Pauli operators at a beginning layer of the Clifford circuit.

Although not explicitly shown in FIG. 17, wherein the error mitigation criterion can be: that the product is equal, up to a global phase, to an identity operator; that the product is equal to a backpropagation of a randomly-inserted Pauli operator in the Clifford circuit; or that the product is present within a set of stabilizers associated with the Clifford circuit.

Although not explicitly shown in FIG. 17, the Clifford circuit can be performed on a quantum computer (e.g., 104), and can further comprise: selecting, by the device and as the set of check qubits, one or more qubits of the quantum computer that are unused by the Clifford circuit.

Although not explicitly shown in FIG. 17, a first check qubit (e.g., C₁ of FIG. 14) of the set of check qubits can be a target of a second check qubit (e.g., C₂ of FIG. 14) of the set of check qubits.

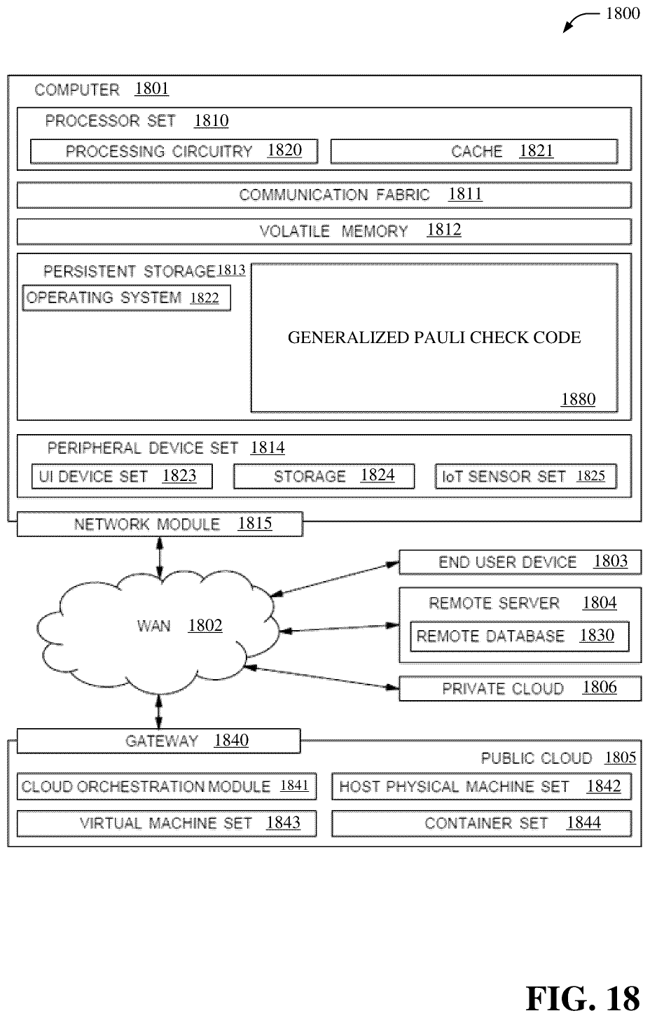

FIG. 18 and the following discussion are intended to provide a brief, general description of a suitable computing environment 1800 in which one or more embodiments described herein can be implemented. For example, various aspects of the present disclosure are described by narrative text, flowcharts, block diagrams of computer systems or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 1800 contains an example of an environment for the execution of at least some of the computer code involved in performing the inventive methods, such as generalized Pauli check code 1880. In addition to block 1880, computing environment 1800 includes, for example, computer 1801, wide area network (WAN) 1802, end user device (EUD) 1803, remote server 1804, public cloud 1805, and private cloud 1806. In this embodiment, computer 1801 includes processor set 1810 (including processing circuitry 1820 and cache 1821), communication fabric 1811, volatile memory 1812, persistent storage 1813 (including operating system 1822 and block 1880, as identified above), peripheral device set 1814 (including user interface (UI), device set 1823, storage 1824, and Internet of Things (IoT) sensor set 1825), and network module 1815. Remote server 1804 includes remote database 1830. Public cloud 1805 includes gateway 1840, cloud orchestration module 1841, host physical machine set 1842, virtual machine set 1843, and container set 1844.

COMPUTER 1801 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1830. As is well understood in the art of computer technology, and depending upon the technology, performance of a computer-implemented method can be distributed among multiple computers or between multiple locations. On the other hand, in this presentation of computing environment 1800, detailed discussion is focused on a single computer, specifically computer 1801, to keep the presentation as simple as possible. Computer 1801 can be located in a cloud, even though it is not shown in a cloud in FIG. 18. On the other hand, computer 1801 is not required to be in a cloud except to any extent as can be affirmatively indicated.

PROCESSOR SET 1810 includes one, or more, computer processors of any type now known or to be developed in the future. Processing circuitry 1820 can be distributed over multiple packages, for example, multiple, coordinated integrated circuit chips. Processing circuitry 1820 can implement multiple processor threads or multiple processor cores. Cache 1821 is memory that is located in the processor chip package(s) and is typically used for data or code that should be available for rapid access by the threads or cores running on processor set 1810. Cache memories are typically organized into multiple levels depending upon relative proximity to the processing circuitry. Alternatively, some, or all, of the cache for the processor set can be located “off chip.” In some computing environments, processor set 1810 can be designed for working with qubits and performing quantum computing.

Computer readable program instructions are typically loaded onto computer 1801 to cause a series of operational steps to be performed by processor set 1810 of computer 1801 and thereby effect a computer-implemented method, such that the instructions thus executed will instantiate the methods specified in flowcharts or narrative descriptions of computer-implemented methods included in this document (collectively referred to as “the inventive methods”). These computer readable program instructions are stored in various types of computer readable storage media, such as cache 1821 and the other storage media discussed below. The program instructions, and associated data, are accessed by processor set 1810 to control and direct performance of the inventive methods. In computing environment 1800, at least some of the instructions for performing the inventive methods can be stored in block 1880 in persistent storage 1813.

COMMUNICATION FABRIC 1811 is the signal conduction path that allows the various components of computer 1801 to communicate with each other. Typically, this fabric is made of switches and electrically conductive paths, such as the switches and electrically conductive paths that make up busses, bridges, physical input/output ports and the like. Other types of signal communication paths can be used, such as fiber optic communication paths or wireless communication paths.

VOLATILE MEMORY 1812 is any type of volatile memory now known or to be developed in the future. Examples include dynamic type random access memory (RAM) or static type RAM. Typically, the volatile memory is characterized by random access, but this is not required unless affirmatively indicated. In computer 1801, the volatile memory 1812 is located in a single package and is internal to computer 1801, but, alternatively or additionally, the volatile memory can be distributed over multiple packages or located externally with respect to computer 1801.

PERSISTENT STORAGE 1813 is any form of non-volatile storage for computers that is now known or to be developed in the future. The non-volatility of this storage means that the stored data is maintained regardless of whether power is being supplied to computer 1801 or directly to persistent storage 1813. Persistent storage 1813 can be a read only memory (ROM), but typically at least a portion of the persistent storage allows writing of data, deletion of data and re-writing of data. Some familiar forms of persistent storage include magnetic disks and solid-state storage devices. Operating system 1822 can take several forms, such as various known proprietary operating systems or open-source Portable Operating System Interface type operating systems that employ a kernel. The code included in block 1880 typically includes at least some of the computer code involved in performing the inventive methods.

PERIPHERAL DEVICE SET 1814 includes the set of peripheral devices of computer 1801. Data communication connections between the peripheral devices and the other components of computer 1801 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 1823 can include components such as a display screen, speaker, microphone, wearable devices (such as goggles and smart watches), keyboard, mouse, printer, touchpad, game controllers, and haptic devices. Storage 1824 is external storage, such as an external hard drive, or insertable storage, such as an SD card. Storage 1824 can be persistent or volatile. In some embodiments, storage 1824 can take the form of a quantum computing storage device for storing data in the form of qubits. In embodiments where computer 1801 is required to have a large amount of storage (for example, where computer 1801 locally stores and manages a large database) then this storage can be provided by peripheral storage devices designed for storing large amounts of data, such as a storage area network (SAN) that is shared by multiple, geographically distributed computers. IoT sensor set 1825 is made up of sensors that can be used in Internet of Things applications. For example, one sensor can be a thermometer and another sensor can be a motion detector.

NETWORK MODULE 1815 is the collection of computer software, hardware, and firmware that allows computer 1801 to communicate with other computers through WAN 1802. Network module 1815 can include hardware, such as modems or Wi-Fi signal transceivers, software for packetizing or de-packetizing data for communication network transmission, or web browser software for communicating data over the internet. In some embodiments, network control functions and network forwarding functions of network module 1815 are performed on the same physical hardware device. In other embodiments (for example, embodiments that utilize software-defined networking (SDN)), the control functions and the forwarding functions of network module 1815 are performed on physically separate devices, such that the control functions manage several different network hardware devices. Computer readable program instructions for performing the inventive methods can typically be downloaded to computer 1801 from an external computer or external storage device through a network adapter card or network interface included in network module 1815.

WAN 1802 is any wide area network (for example, the internet) capable of communicating computer data over non-local distances by any technology for communicating computer data, now known or to be developed in the future. In some embodiments, the WAN can be replaced or supplemented by local area networks (LANs) designed to communicate data between devices located in a local area, such as a Wi-Fi network. The WAN or LANs typically include computer hardware such as copper transmission cables, optical transmission fibers, wireless transmission, routers, firewalls, switches, gateway computers and edge servers.

END USER DEVICE (EUD) 1803 is any computer system that is used and controlled by an end user (for example, a customer of an enterprise that operates computer 1801) and can take any of the forms discussed above in connection with computer 1801. EUD 1803 typically receives helpful and useful data from the operations of computer 1801. For example, in a hypothetical case where computer 1801 is designed to provide a recommendation to an end user, this recommendation would typically be communicated from network module 1815 of computer 1801 through WAN 1802 to EUD 1803. In this way, EUD 1803 can display, or otherwise present, the recommendation to an end user. In some embodiments, EUD 1803 can be a client device, such as thin client, heavy client, mainframe computer or desktop computer.

REMOTE SERVER 1804 is any computer system that serves at least some data or functionality to computer 1801. Remote server 1804 can be controlled and used by the same entity that operates computer 1801. Remote server 1804 represents the machine(s) that collect and store helpful and useful data for use by other computers, such as computer 1801. For example, in a hypothetical case where computer 1801 is designed and programmed to provide a recommendation based on historical data, then this historical data can be provided to computer 1801 from remote database 1830 of remote server 1804.

PUBLIC CLOUD 1805 is any computer system available for use by multiple entities that provides on-demand availability of computer system resources or other computer capabilities, especially data storage (cloud storage) and computing power, without direct active management by the scale. The direct and active management of the computing resources of public cloud 1805 is performed by the computer hardware or software of cloud orchestration module 1841. The computing resources provided by public cloud 1805 are typically implemented by virtual computing environments that run on various computers making up the computers of host physical machine set 1842, which is the universe of physical computers in or available to public cloud 1805. The virtual computing environments (VCEs) typically take the form of virtual machines from virtual machine set 1843 or containers from container set 1844. It is understood that these VCEs can be stored as images and can be transferred among and between the various physical machine hosts, either as images or after instantiation of the VCE. Cloud orchestration module 1841 manages the transfer and storage of images, deploys new instantiations of VCEs and manages active instantiations of VCE deployments. Gateway 1840 is the collection of computer software, hardware and firmware allowing public cloud 1805 to communicate through WAN 1802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1806 is similar to public cloud 1805, except that the computing resources are only available for use by a single enterprise. While private cloud 1806 is depicted as being in communication with WAN 1802, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, or data/application portability between the multiple constituent clouds. In this embodiment, public cloud 1805 and private cloud 1806 are both part of a larger hybrid cloud.

The embodiments described herein can be directed to one or more of a system, a method, an apparatus or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, or source code or object code written in any combination of one or more programming languages, including an object oriented programming language such as Smalltalk, C++ or the like, or procedural programming languages, such as the “C” programming language or similar programming languages. The computer readable program instructions can execute entirely on a computer, partly on a computer, as a stand-alone software package, partly on a computer or partly on a remote computer or entirely on the remote computer or server. In the latter scenario, the remote computer can be connected to a computer through any type of network, including a local area network (LAN) or a wide area network (WAN), or the connection can be made to an external computer (for example, through the Internet using an Internet Service Provider). In one or more embodiments, electronic circuitry including, for example, programmable logic circuitry, field-programmable gate arrays (FPGA) or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations or block diagrams of methods, apparatus (systems), and computer program products according to one or more embodiments described herein. It will be understood that each block of the flowchart illustrations or block diagrams, and combinations of blocks in the flowchart illustrations or block diagrams, can be implemented by computer readable program instructions. These computer readable program instructions can be provided to a processor of a general-purpose computer, special purpose computer or other programmable data processing apparatus to produce a machine, such that the instructions, which execute via the processor of the computer or other programmable data processing apparatus, can create means for implementing the functions/acts specified in the flowchart or block diagram block or blocks. These computer readable program instructions can also be stored in a computer readable storage medium that can direct a computer, a programmable data processing apparatus or other devices to function in a particular manner, such that the computer readable storage medium having instructions stored therein can comprise an article of manufacture including instructions which can implement aspects of the function/act specified in the flowchart or block diagram block or blocks. The computer readable program instructions can also be loaded onto a computer, other programmable data processing apparatus or other device to cause a series of operational acts to be performed on the computer, other programmable apparatus or other device to produce a computer implemented process, such that the instructions which execute on the computer, other programmable apparatus or other device implement the functions/acts specified in the flowchart or block diagram block or blocks.

The flowcharts and block diagrams in the figures illustrate the architecture, functionality or operation of possible implementations of systems, computer-implementable methods or computer program products according to one or more embodiments described herein. In this regard, each block in the flowchart or block diagrams can represent a module, segment or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, or the blocks can sometimes be executed in the reverse order, depending upon the functionality involved. It will also be noted that each block of the block diagrams or flowchart illustration, or combinations of blocks in the block diagrams or flowchart illustration, can be implemented by special purpose hardware-based systems that can perform the specified functions or acts or carry out one or more combinations of special purpose hardware or computer instructions.

While the subject matter has been described above in the general context of computer-executable instructions of a computer program product that runs on a computer or computers, those skilled in the art will recognize that the one or more embodiments herein also can be implemented at least partially in parallel with one or more other program modules. Generally, program modules include routines, programs, components or data structures that perform particular tasks or implement particular abstract data types. Moreover, the aforedescribed computer-implemented methods can be practiced with other computer system configurations, including single-processor or multiprocessor computer systems, mini-computing devices, mainframe computers, as well as computers, hand-held computing devices (e.g., PDA, phone), or microprocessor-based or programmable consumer or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” or “interface” can refer to or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, where the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter described herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

The herein disclosure describes non-limiting examples of various embodiments. For ease of description or explanation, various portions of the herein disclosure utilize the term “each”, “every”, or “all” when discussing various embodiments. Such usages of the term “each”, “every”, or “all” are non-limiting examples. In other words, when the herein disclosure provides a description that is applied to “each”, “every”, or “all” of some particular object or component, it should be understood that this is a non-limiting example of various embodiments, and it should be further understood that, in various other embodiments, it can be the case that such description applies to fewer than “each”, “every”, or “all” of that particular object or component.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches or gates, in order to optimize space usage or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) or Rambus dynamic RAM (RDRAM). Also, the described memory components of systems or computer-implemented methods herein are intended to include, without being limited to including, these or any other suitable types of memory.

What has been described above includes mere examples of systems and computer-implemented methods. It is, of course, not possible to describe every conceivable combination of components or computer-implemented methods for purposes of describing the one or more embodiments, but one of ordinary skill in the art can recognize that many further combinations or permutations of the one or more embodiments are possible. Furthermore, to the extent that the terms “includes,” “has,” “possesses,” and the like are used in the detailed description, claims, appendices or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A system, comprising:
a processor that executes computer-executable instructions stored in a non-transitory computer-readable memory, which causes the processor to facilitate operations comprising:
performing a Clifford circuit on a set of data qubits; and
detecting an error in performance of the Clifford circuit by measuring a set of check qubits that control a set of Pauli operators that are inserted within the Clifford circuit, wherein a product of backpropagations of the set of Pauli operators satisfies an error mitigation criterion.

2. The system of claim 1, wherein the processor identifies the set of Pauli operators to be inserted within the Clifford circuit based on:
computing respective backpropagations for candidate Pauli operators associated with candidate locations in the Clifford circuit, thereby yielding a plurality of candidate backpropagations;
stacking respective Boolean encodings of the plurality of candidate backpropagations, thereby yielding a stacked array; and
computing a nullspace of the stacked array.

3. The system of claim 1, wherein the processor computes the backpropagations of the set of Pauli operators at a beginning layer of the Clifford circuit.

4. The system of claim 1, wherein the error mitigation criterion is that the product is equal, up to a global phase, to an identity operator.

5. The system of claim 1, wherein the error mitigation criterion is that the product is equal to a backpropagation of a randomly-inserted Pauli operator in the Clifford circuit.

6. The system of claim 1, wherein the error mitigation criterion is that the product is present within a set of stabilizers associated with the Clifford circuit.

7. The system of claim 1, wherein the Clifford circuit is performed on a quantum computer, and wherein the operations further comprise:
selecting as the set of check qubits one or more qubits of the quantum computer that are unused by the Clifford circuit.

8. The system of claim 1, wherein a first check qubit of the set of check qubits is a target of a second check qubit of the set of check qubits.

9. A computer-implemented method, comprising:
performing, by a device operatively coupled to a processor, a Clifford circuit on a set of data qubits; and
detecting, by the device, an error in performance of the Clifford circuit by measuring a set of check qubits that control a set of Pauli operators that are inserted within the Clifford circuit, wherein a product of backpropagations of the set of Pauli operators satisfies an error mitigation criterion.

10. The computer-implemented method of claim 9, wherein the device identifies the set of Pauli operators to be inserted within the Clifford circuit based on:
computing, by the device, respective backpropagations for candidate Pauli operators associated with candidate locations in the Clifford circuit, thereby yielding a plurality of candidate backpropagations;
stacking, by the device, respective Boolean encodings of the plurality of candidate backpropagations, thereby yielding a stacked array; and
computing, by the device, a nullspace of the stacked array.

11. The computer-implemented method of claim 9, wherein the device computes the backpropagations of the set of Pauli operators at a beginning layer of the Clifford circuit.

12. The computer-implemented method of claim 9, wherein the error mitigation criterion is that the product is equal, up to a global phase, to an identity operator.

13. The computer-implemented method of claim 9, wherein the error mitigation criterion is that the product is equal to a backpropagation of a randomly-inserted Pauli operator in the Clifford circuit.

14. The computer-implemented method of claim 9, wherein the error mitigation criterion is that the product is present within a set of stabilizers associated with the Clifford circuit.

15. The computer-implemented method of claim 9, wherein the Clifford circuit is performed on a quantum computer, and further comprising:
selecting, by the device and as the set of check qubits, one or more qubits of the quantum computer that are unused by the Clifford circuit.

16. The computer-implemented method of claim 9, wherein a first check qubit of the set of check qubits is a target of a second check qubit of the set of check qubits.

17. A computer program product for facilitating error mitigation for Clifford circuits via generalized Pauli checks, the computer program product comprising a non-transitory computer-readable memory having program instructions embodied therewith, the program instructions executable by a processor to cause the processor to:
perform a Clifford circuit on a set of data qubits; and
detect an error in performance of the Clifford circuit by measuring a set of check qubits that control a set of Pauli operators that are inserted within the Clifford circuit, wherein a product of backpropagations of the set of Pauli operators satisfies an error mitigation criterion.

18. The computer program product of claim 17, wherein the processor identifies the set of Pauli operators to be inserted within the Clifford circuit based on:
computing respective backpropagations for candidate Pauli operators associated with candidate locations in the Clifford circuit, thereby yielding a plurality of candidate backpropagations;
stacking respective Boolean encodings of the plurality of candidate backpropagations, thereby yielding a stacked array; and
computing a nullspace of the stacked array.

19. The computer program product of claim 17, wherein the processor computes the backpropagations of the set of Pauli operators at a beginning layer of the Clifford circuit.

20. The computer program product of claim 17, wherein the error mitigation criterion is that the product is equal, up to a global phase, to an identity operator.
